(19) United States
(12) Patent Application Publication
(10) Pub. No.: US 2024/0302505 A1
(43) Pub. Date: Sep. 12, 2024

(54) DETECTION SYSTEM AND METHOD OF PERFORMING A TIME MEASUREMENT

(71) Applicant: OSRAM GmbH, Munich (DE)

(72) Inventor: Gerhard MAIERBACHER, Munich (DE)

(21) Appl. No.: 18/551,405

(22) PCT Filed: Mar. 22, 2022
(86) PCT No.: PCT/EP2022/057473

§ 371 Date: Sep. 20, 2023

(30) Foreign Application Priority Data
Mar. 23, 2021 (DE) 10 2021 107 145.3

(51) Int. Cl. G01S 7/4865; G01S 17/894

(52) U.S. Cl. CPC G01S 7/4865; G01S 17/894

(57) ABSTRACT

According to various aspects a detection system may include: a detector circuit configured to detect a signal; an integrator circuit configured to integrate the detected signal responsive to an integration start signal and to generate an integration value; and a processing circuit configured to: detect a change of the detected signal from below to above a predefined trigger threshold value and, in the case that the change of the detected signal is detected, transmit the integration start signal to the integrator circuit; determine a time between a provided time measurement start signal and the detection of the change of the detected signal as a time measurement associated with the detected signal; and determine one or more characteristics of the detected signal using the generated integration value.

### RELATED APPLICATION(S)

This is a US National Stage Application of International Application PCT/EP2022/057473, filed on 22 Mar. 2022, and claims priority under 35 U.S.C. § 119(a) and 35 U.S.C. § 365(b) from German Application 10 2021 107 145.3, filed on 23 Mar. 2021, the contents of which are incorporated herein by reference in their entirety.

### FIELD

This present disclosure generally relates to detection systems and methods of performing a time measurement, and various aspects are related to a LIDAR (“Light Detection and Ranging”) system including the detection system.

### BACKGROUND

Light detection and ranging is a sensing technique that is used, for example, in the field of autonomous driving for providing detailed information about the surrounding of an automated or partially automated vehicle. Light is used to scan a scene and determine the properties (e.g., the location, the speed, the direction of motion, and the like) of the objects present therein. A LIDAR system may use the time-of-flight (ToF) of the emitted light to measure the distance to an object. A LIDAR system may include one of a high-speed analog-to-digital converter (ADC) or a time-to-digital converter (TDC) for processing the light received from the scene. An ADC-based solution may provide information about the signal level of the received pulse, including its peak value, or information about the shape of the received pulse, which may be useful for object detection and object fusion (the respective algorithms may make use of peak information). However, a high-speed ADC may be expensive in terms of power consumption, heat, cost, complexity, etc. Furthermore, the continuous full waveform sampling at high sampling rates generates large amounts of data which need to be communicated and processed. In addition, not all detectors provide information about the signal level of the received pulse (e.g., single photon avalanche diode (SPAD) detectors do not provide such information). A LIDAR architecture adopting a TDC approach may have various advantages with respect to an ADC approach: (1) a simple system setup that reduces the number of expensive components while being suitable for high-speed implementations; (2) compared to waveform sampling solutions no high-speed ADC is needed, which may be beneficial with respect to power consumption and cost; and (3) in view of the event-based nature of a TDC detection scheme the amount of generated data may be relatively small, thus reducing the amount of data to process (illustratively, less CPU load is generated) and reducing the needed CPU-power, which also leads to a decrease in the power consumption and cost of the system. However, a limitation of a usual TDC-based system is that it does not provide detailed information about characteristics of a light signal, e.g. peak value of a pulse and/or pulse-shape information. An approach including a plurality of comparators each providing its output to a respective time-to-digital converter is described in U.S. Ser. No. 10/802,120 Bl. Further, TDC-based systems are prone to timing-errors (e.g., a walk-error or a black-white-error) since a time of detecting a signal is associated with a shape of the signal and a peak value of the signal, which may both be unknown. Thus, it may be desirable to provide a TDC-based system which is capable to compensate the timing-error caused by the signal shape and peak value of the signal. Further, it may be desirable to provide a TDC-based system which is capable to provide, besides the timing-error, further information about characteristics of the signal, such as an energy of the signal, the peak value of the signal, and/or the shape of the signal.

Various aspects may be related to a detection system configured according to a TDC conversion approach and adapted to determine additional information (e.g., a time offset, a signal energy, a peak value, and/or shape information) associated with a detected signal, which are not determined in a conventional TDC-based detection system. Various aspects are related to a detection system configured to process a received signal in a way that, compared to a conventional TDC-approach, enables extraction of a time-offset, a peak value, an energy, and/or shape information (e.g., in addition to time-of-flight information). The TDC-approach described herein may also be referred to in the following as adapted TDC-approach. Various aspects relate to a detection system and a method of performing a time measurement which are capable of determining characteristics of the detected signal. Further, the detection system and the method are capable of determining a time-offset associated with the detected signal and, hence, compensating the timing-error of the detected signal caused by the signal shape and peak value.

The additional information provided by the adapted TDC-strategy described herein may be advantageous, for example, for determining the reflectance or other surface properties of an object. As a further example, the strategy described herein may be advantageous for other subsequent processing steps like object detection, object tracking, and sensor fusion stages.

In the context of the present description, reference may be made to the detection and processing of a “signal”. The “signal” may be or may include any type of analog signal for which the adapted TDC-approach described herein may be applied. The detection system and the method of processing described herein may be used for different types of analog signals, such as an electrical signal, a light signal, an ultrasound signal, a RADAR signal, a radiofrequency signal, as examples. Particular reference may be made to detection and processing of a “light signal”, e.g. in the context of LIDAR applications. It is however understood that a light signal is only an example used to illustrate a possible application of the adapted TDC-approach described herein.

In the context of the present description, reference may be made to a peak value and/or shape information to describe the “additional information” that the adapted TDC-approach may provide. It is however understood that the processing described herein may also provide that other type of signal-related information may be extracted from a determined digitized signal, such as a number of pulses included in the signal, or the number and relative peak values (e.g., an amplitude) of pulses in a multi-pulse signal, as other examples.

In the context of the present description, reference may be made to a LIDAR system, which may include the detection system described herein. A LIDAR system may include various components and sensors for monitoring a scene (e.g., an environment surrounding a vehicle), as commonly known in the art. By way of example, a LIDAR system may include a brightness sensor, a presence sensor, an optical camera, a RADAR sensing system, an ultrasonic sensing system, and/or a light-based sensing system. A LIDAR system may include one or more actuators for adjusting the environmental surveillance conditions, e.g. one or more actuators for adapting the emission direction of light, for adapting the orientation of an optical camera, for adapting the emission direction of ultrasonic waves, and the like. A LIDAR system may include a data processing circuit for processing the data provided by the sensors. The data processing circuit may include, for example, a sensor fusion module for combining the data provided by different types of sensors and enhancing the monitoring of the scene. The data processing circuit may be configured to carry out object recognition and/or object classification to analyze the object(s) present in the monitored scene. The object recognition and/or object classification may be based on the data provided by the sensors (e.g., by one or more of the available sensors). A LIDAR system may include one or more memories storing information and instructions, such as the sensed data, the determined object information, instructions on how to operate the sensors, and the like. A LIDAR system may include one or more communication interfaces to communicate with other systems (e.g., other systems of a same vehicle, or another LIDAR system of another vehicle, as examples), e.g. configured for wired- and/or wireless-communication.

It is understood that a LIDAR system is an example of a possible application of the adapted TDC-based detection strategy described herein. The method and the detection system described herein may also be for use in other types of application or systems in which determining additional information (e.g., a peak value and/or shape) of a signal may be advantageous, for example in an optical transmission system (e.g., wireless or including optical fibers), e.g. in a system in which data and information may be transmitted by means of light. The method and the detection system described herein may be for use in applications in which a time-based detection of a short signal (e.g., with a duration less than 500 ns, or less than 100 ns) is to be provided. The high-speed temporal signal capturing capabilities combined with the peak value/pulse-shape reconstruction features provide the means to capture, store, and process high-speed signals with an arbitrary waveform. This may be particularly relevant in applications where high-speed ADC solutions are either too costly, too complex to implement, or simply not yet fast enough. Potential applications may range from detectors that are used in particle accelerators to low-cost signal capturing applications in the consumer and automotive domain.

In various aspects, a detection system may include a detector circuit configured to detect a signal and to provide the detected signal; an integrator circuit configured to integrate the detected signal responsive to an integration start signal and to generate an integration value representing a result of the integration of the detected signal over time; and a processing circuit configured to: detect a change of the detected signal from below to above a predefined trigger threshold value and, in the case that the change of the detected signal from below to above the predefined trigger threshold value is detected, transmit the integration start signal to the integrator circuit; determine a time between a provided time measurement start signal and the detection of the change of the detected signal as a time measurement associated with the detected signal; and determine one or more characteristics of the detected signal using the generated integration value.

The expression “signal level” may be used herein to describe a parameter associated with a signal or with a portion of a signal (e.g., with a peak). A “signal level” as used herein may include a power level, a current level, a voltage level, or a peak level (also referred to herein as peak value), etc.

The term “peak value” may be used herein to describe the height of a peak, e.g. the height of a pulse. The term “peak value” may describe the signal level of the signal at the peak with respect to a reference value for the signal level. In this regard, the term “peak value” may be understood to describe the maximum value of the signal (e.g., of the peak) as measured from the reference value of the signal level.

The term “processor” as used herein may be understood as any kind of technological entity that allows handling of data. The data may be handled according to one or more specific functions executed by the processor. Further, a processor as used herein may be understood as any kind of circuit, e.g., any kind of analog or digital circuit. A processor may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor or logic circuit. It is understood that any two (or more) of the processors or logic circuits detailed herein may be realized as a single entity with equivalent functionality or the like, and conversely that any single processor or logic circuit detailed herein may be realized as two (or more) separate entities with equivalent functionality or the like.

The term “circuit” as used herein may be understood as any kind of a logic implementing entity, which may be hardware, software, firmware, or any combination thereof. In some aspects, a “circuit” may be an analog or digital electronic element. A “circuit” may be a separate electronic component including one or more electronic elements and being interconnected with other electronic components. According to various aspects, several “circuits” may be part of an electronic component.

### BRIEF DESCRIPTION OF THE DRAWINGS

In the drawings, like reference characters generally refer to the same parts throughout the different views. The drawings are not necessarily to scale, emphasis instead generally being placed upon illustrating the principles disclosed herein. In the following description, various aspects disclosed herein are described with reference to the following drawings, in which:

FIG. 1A to FIG. 1E each shows schematically a detection system according to various aspects;

FIG. 2A illustratively shows a timing-error dependent on a peak value of a signal, according to various aspects;

FIG. 2B shows a graphical determination of a time difference between a time of detecting a signal and a time corresponding to a reference feature of the signal, according to various aspects;

FIG. 2C and FIG. 2D show a graphical representation of lookup-tables in accordance with various aspects;

FIG. 3A, FIG. 4A, FIG. 4B, FIG. 5A, FIG. 6A, and FIG. 7 each shows a respective detection system according to various aspects;

FIG. 3B, FIG. 4C, FIG. 5B, FIG. 5C, FIG. 6B, and FIG. 6C each shows a respective timing diagram associated with a respective detection system, according to various aspects;

FIG. 8A to FIG. 8F each shows a LIDAR system according to various aspects; and

FIG. 9 shows a method of performing a time measurement according to various aspects.

### DETAILED DESCRIPTION

The following detailed description refers to the accompanying drawings that show, by way of illustration, specific details and implementations in which the aspects disclosed herein may be practiced. These aspects are described in sufficient detail to enable those skilled in the art to practice the disclosed implementations. Other aspects may be utilized and structural, logical, and electrical changes may be made without departing from the scope of the disclosed implementations. The various aspects are not necessarily mutually exclusive, as some aspects may be combined with one or more other aspects to form new aspects. Various aspects are described in connection with methods and various aspects are described in connection with devices (e.g., a detection system, a processing circuit, a detector circuit, an integrator circuit, etc.). However, it is understood that aspects described in connection with methods may similarly apply to the devices, and vice versa.

A detection system may use a time-to-digital converter (TDC) approach, which may reduce the number of expensive components and may reduce the amount of generated data. However, a limitation of a usual TDC-based system is that it does not provide detailed information about the properties of a detected signal. Various aspects of this disclosure provide a detection system and a method of performing a time measurement, which employ a TDC-based approach and are capable determine characteristics of the detected signal, such as an energy of the detected signal, a peak value of the detected signal, a shape of the detected signal, and/or a timing-error caused by the signal shape and the peak value of the detected signal (e.g., a walk-error).

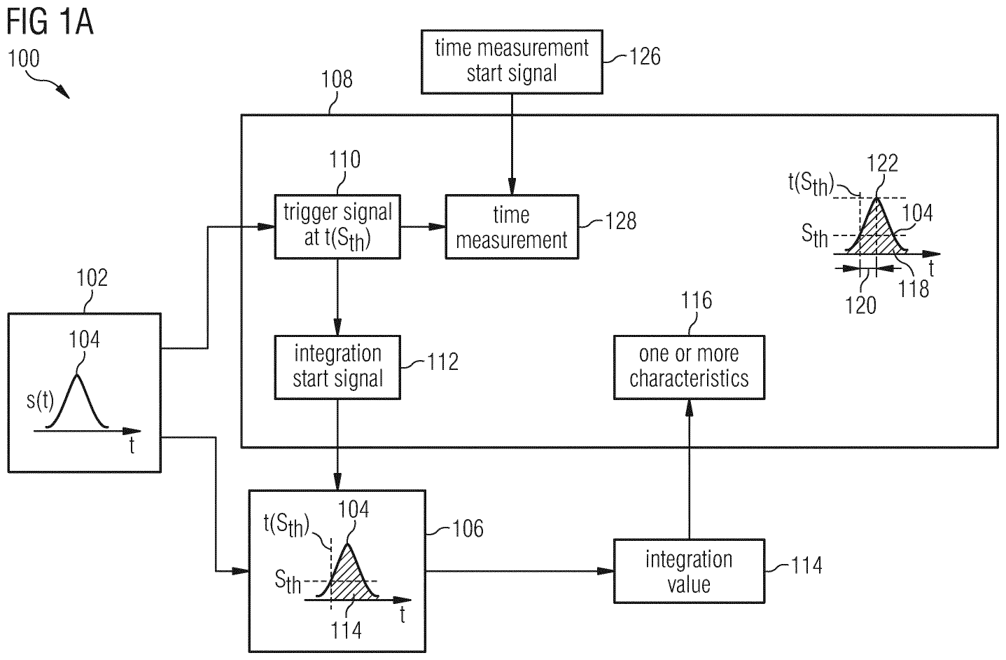

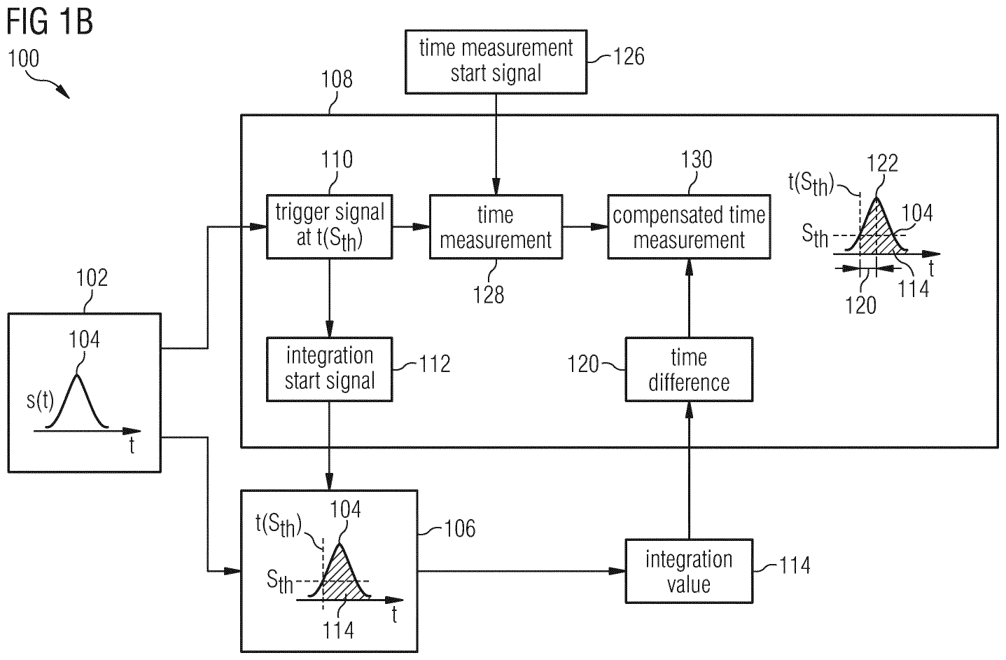

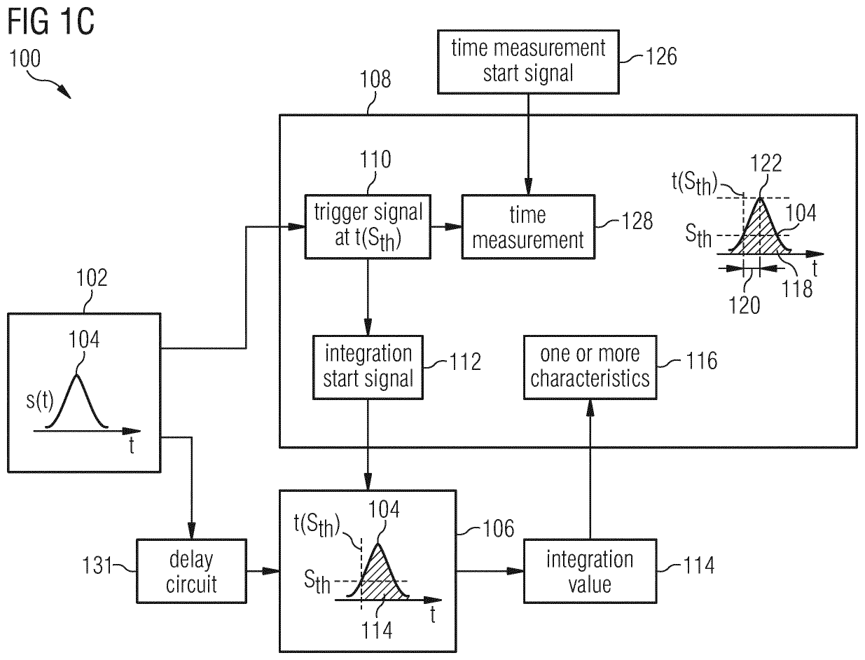

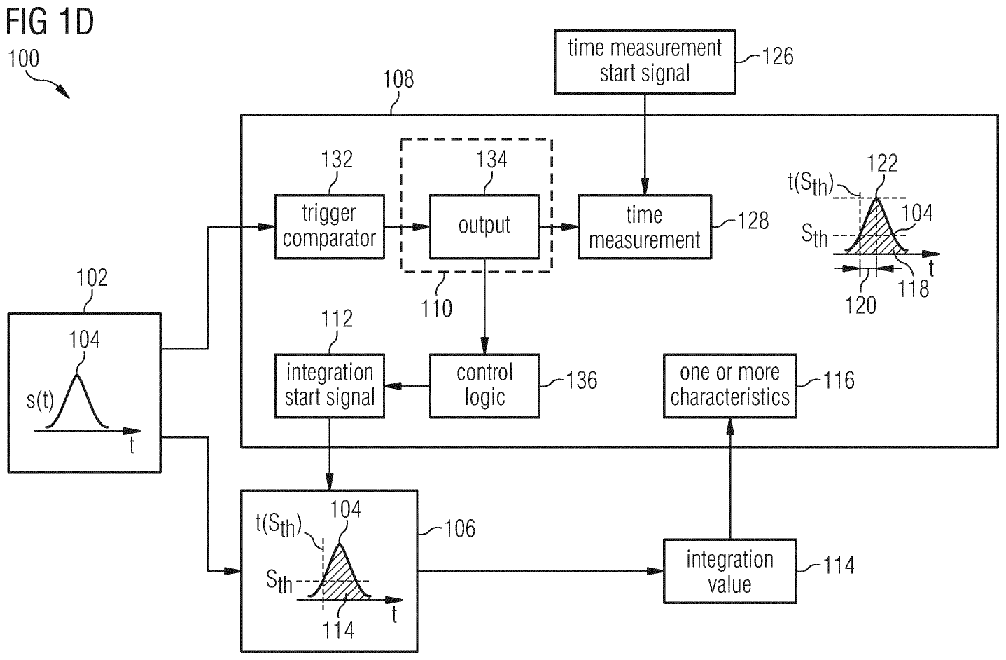

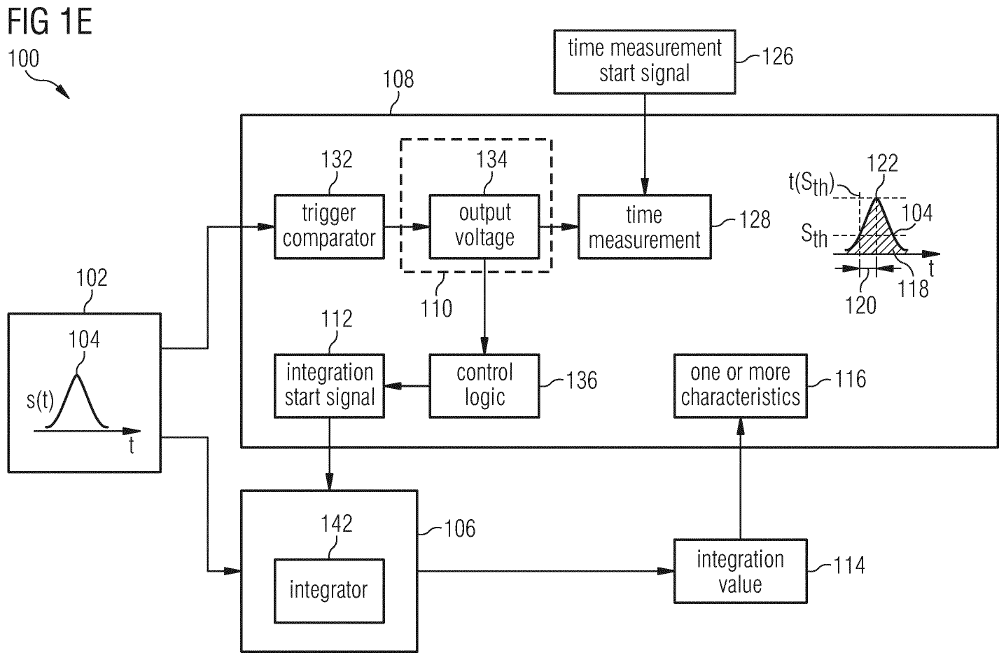

FIG. 1A to FIG. 1E each shows schematically a detection system 100 according to various aspects. In some aspects, the detection system 100 may be a light detection system, e.g. in case a signal to be detected (and processed) is or includes a light signal. In some aspects, the detection system 100 may be a light detection system for use in a LIDAR system. In some aspects, a LIDAR system may include one or more detection systems 100.

The detection system 100 may include a detector circuit 102. The detector circuit 102 may be configured to detect a signal 104. According to various aspects, the detector circuit 102 may be configured to provide the detected signal 104. For example, the detector circuit 102 may be configured to output the detected signal 104. The detected signal 104 may be a signal over time s(t). According to various aspects, the detector circuit 102 may be configured to detect a signal, such as an electrical signal, a light signal, an ultrasound signal, a RADAR signal, a radiofrequency signal, as examples, and to provide (e.g., output) an analog signal (e.g., a current or a voltage) associated with the detected signal 104. According to various aspects, the detected signal 104 may be a signal pulse. The signal pulse may have a duration in the range from 0.1 ns to 1000 ns (e.g., in the range from 1 ns to 100 ns). For example, the signal pulse may be a light signal pulse and the light signal pulse may have a duration of 10 ns.

The detection system 100 may include an integrator circuit 106. According to various aspects, the detector circuit 102 may be configured to provide (e.g., transmit) the detected signal 104 to the integrator circuit 106. The detector circuit 102 may be configured to transmit the detected signal 104 to the integrator circuit 106 over time (e.g., provide the signal s over time t). The integrator circuit 106 may be configured to integrate the detected signal 104. The integrator circuit 106 may be configured to integrate the detected signal 104 responsive to an integration start signal 112. According to various aspects, the integrator circuit 106 may be configured to generate an integration value 114 representing a result of the integration of the detected signal 104 over time. For example, as illustratively shown in FIG. 1A, the integrator circuit 106 may receive the integration start signal 112 at a time t(sₜₕ) and may integrate the detected signal 104 starting from the time t(sₜₕ) resulting in an integral 114 of the detected signal 104. According to various aspects, the integrator circuit 106 may be configured to stop integrating the detected signal 104 responsive to an integration stop signal. The generated integration value 114 may represent the integral of the detected signal 104 from the time t(sₜₕ) of receiving the integration start signal 112 to the time of receiving the integration stop signal.

The detection system 100 may include a processing circuit 108. According to various aspects, the detector circuit 102 may be configured to provide (e.g., transmit) the detected signal 104 to the processing circuit 108. The detector circuit 102 may be configured to transmit the detected signal 104 to the processing circuit 108 over time (e.g., provide the signal s over time t). The processing circuit 108 may be configured to detect a change of the detected signal 104 from below to above a predefined trigger threshold value sₜₕ. According to various aspects, the processing circuit 108 may be configured to transmit the integration stop signal to the integrator circuit 104. According to various aspects, the integrator circuit 106 may be configured to generate the integration stop signal.

A threshold value as used herein may include a threshold signal level that may be associated with (e.g., expressed in relation to) a signal power or a signal intensity, for example a threshold level may include at least one of a threshold current or a threshold voltage. For example, the detected signal 104, s(t), transmitted by the detector circuit 102 may be a voltage over time and the predefined trigger threshold value, sₜₕ, may be a predefined trigger threshold voltage value. For example, the detected signal 104, s(t), transmitted by the detector circuit 102 may be a current over time and the predefined trigger threshold value, sₜₕ, may be a predefined trigger threshold current value.

A time of detecting the change of the detected signal 104 from below to above the predefined trigger threshold value, sₜₕ, may be a trigger time, t(sₜₕ). According to various aspects, the processing circuit 108 may be configured to provide a trigger signal 110 at the trigger time, t(sₜₕ), representing the change of the detected signal 104 from below to above the predefined trigger threshold value, sₜₕ.

According to various aspects, the processing circuit 108 may be configured to transmit the integration start signal 112 to the integrator circuit 106 responsive to detecting the trigger signal 110. The processing circuit 108 may be configured to transmit the integration start signal 112 to the integrator circuit 106 in the case that the change of the detected signal 104 from below to above the predefined trigger threshold value, sₜₕ, is detected. It is noted that there may be a time delay between detecting the trigger signal 110 (e.g., detecting a change of an output 134 of a trigger comparator 132 as described with reference to FIG. 1D) and the time the integrator circuit 106 reacts on the integration start signal 112 and effectively starts integrating. For example, the time delay may be caused by the processing circuit 108 detecting the trigger signal 110 (e.g., detecting the change of the output 134 of the trigger comparator 132 as described with reference to FIG. 1D) and/or by an internal delay of the integrator circuit 106. In the following, for illustration purposes the integrator circuit 106 is described as starting to integrate at the trigger time t(sₜₕ). According to various aspects, the time delay may be considered as negligibly small or a value of the time delay may be considered in the time determinations (e.g., calculations) described herein. According to various aspects, the processing circuit 108 may be configured to transmit the integration stop signal to the integrator circuit 106. The processing circuit 108 may be configured to transmit the integration stop signal to the integrator circuit 106 a predefined time period after the integration start signal 112 has been transmitted to the integrator circuit 106. According to various aspects, the predefined time period may be selected based on an expected duration of the detected signal.

According to various aspects, the processing circuit 108 may be configured to determine one or more characteristics 116 of the detected signal 104 using the generated integration value 114. For example, the one or more characteristics 116 of the detected signal 104 may include an energy 118 of the detected signal 104.

According to various aspects, the processing circuit 108 may be configured to determine the energy 118 of the detected signal 104 using only the generated integration value 114 (e.g., in the case that the predefined trigger threshold value, sₜₕ, is selected such that the predefined trigger threshold value, sₜₕ, is slightly greater than the noise level of the detected signal 104). Illustratively, each signal s(t) greater than the noise level of the detected signal 104 may result in the detection of the trigger signal 110.

According to various aspects, the processing circuit 108 may be configured to determine the energy 118 of the detected signal 104 using the generated integration value 114, the predefined trigger threshold value, sₜₕ, and expected properties of the detected signal 104 (e.g., in the case that the predefined trigger threshold value, sₜₕ, is greater than twice the noise level of the detected signal 104). The expected properties of the detected signal 104 may include, for example, an expected shape (e.g., a Gaussian shape) of the detected signal 104, an expected duration (e.g., in the range from 0.1 ns to 1000 ns) of the detected signal 104, etc. Illustratively, the generated integration value 114 may represent a partial integral of the detected signal 104 from the trigger time, t(sₜₕ), to an end of the signal (e.g., a time at which the signal s(t) is below the noise level; this may correspond substantially to the integral of the detected signal 104 from the trigger time, t(sₜₕ), to infinity) and by assuming expected properties of the detected signal 104, such as an expected shape and an expected duration, the energy 118 of the detected signal 104 may be determined (e.g., calculated).

For example, the one or more characteristics 116 of the detected signal 104 may include a peak value 122 of the detected signal 104. The processing circuit 108 may be configured to determine the peak value 122 of the detected signal 104 using the generated integration value 114 and the expected properties of the detected signal 104 (e.g., in the case that the predefined trigger threshold value, sₜₕ, is selected such that the predefined trigger threshold value, sₜₕ, is slightly greater than the noise level of the detected signal 104). The processing circuit 108 may be configured to determine the peak value 122 of the detected signal 104 using the generated integration value 114, the predefined trigger threshold value, sₜₕ, and the expected properties of the detected signal 104 (e.g., in the case that the predefined trigger threshold value, sₜₕ, is greater than twice the noise level of the detected signal 104).

According to various aspects, the predefined trigger threshold value, sₜₕ, may be adjusted (e.g., increased, e.g., reduced) based on the determined peak value 122.

For example, the one or more characteristics 116 of the detected signal 104 may include a time difference 120 (see, for example, FIG. 1B) between a time corresponding to the detected change of the detected signal 104 (e.g., the trigger time t(sₜₕ) and a time corresponding to a reference feature of the detected signal 104. The reference feature of the detected signal 104 may be a reference characteristics or a reference position of the detected signal 104. For example, the reference feature of the detected signal 104 may be a peak value or a half-maximum of the detected signal 104. It is noted that the reference feature of the detected signal 104 may be any feature related to a respective shape of a signal (e.g., a pulse). For illustration, FIG. 1A to FIG. 1E show the peak value 122 as the reference feature of the detected signal 104. In this example, the time difference 120 may be a time between the trigger time, t(sₜₕ), and the time corresponding to the peak value 122.

According to various aspects, the processing circuit 108 may be configured to determine the time difference 120 between the trigger time, t(sₜₕ), and the time corresponding to the reference feature of the detected signal 104 using the generated integration value 114 and the expected properties of the detected signal 104 (e.g., in the case that the predefined trigger threshold value, sₜₕ, is selected such that the predefined trigger threshold value, sₜₕ, is slightly greater than the noise level of the detected signal 104). According to various aspects, the processing circuit 108 may be configured to determine the time difference 120 between the trigger time, t(sₜₕ), and the time corresponding to the reference feature of the detected signal 104 using the generated integration value 114, the predefined trigger threshold value, sₜₕ, and the expected properties of the detected signal 104 (e.g., in the case that the predefined trigger threshold value, sₜₕ, is greater than twice the noise level of the detected signal 104).

According to various aspects, the processing circuit 108 may be configured to determine a time between a provided time measurement start signal 126 and the detection of the change of the detected signal 104 from below to above the predefined trigger threshold value, sₜₕ, as a time measurement 128 associated with the detected signal 104. For example, the processing circuit 108 may be configured to determine the time between the time measurement start signal 126 and the trigger signal 110. According to various aspects, the detection system 100 may include a clock signal generator configured to provide a clock signal to the processing circuit 108. The processing circuit 108 may be configured to receive the clock signal and to determine the time between the time measurement start signal 126 and the trigger signal 110 in accordance with the clock signal (e.g., counting a number of clock cycles).

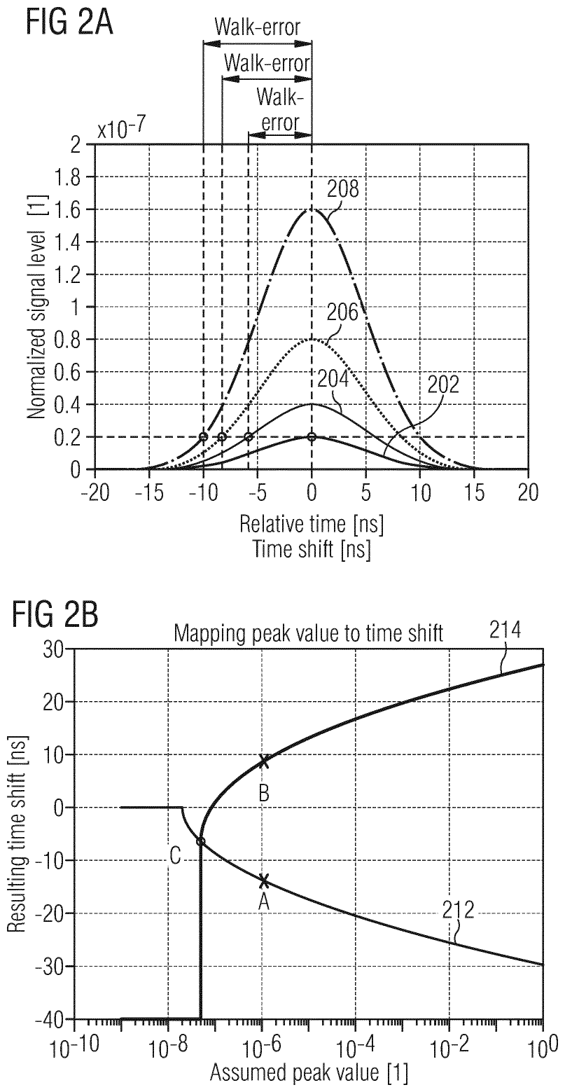

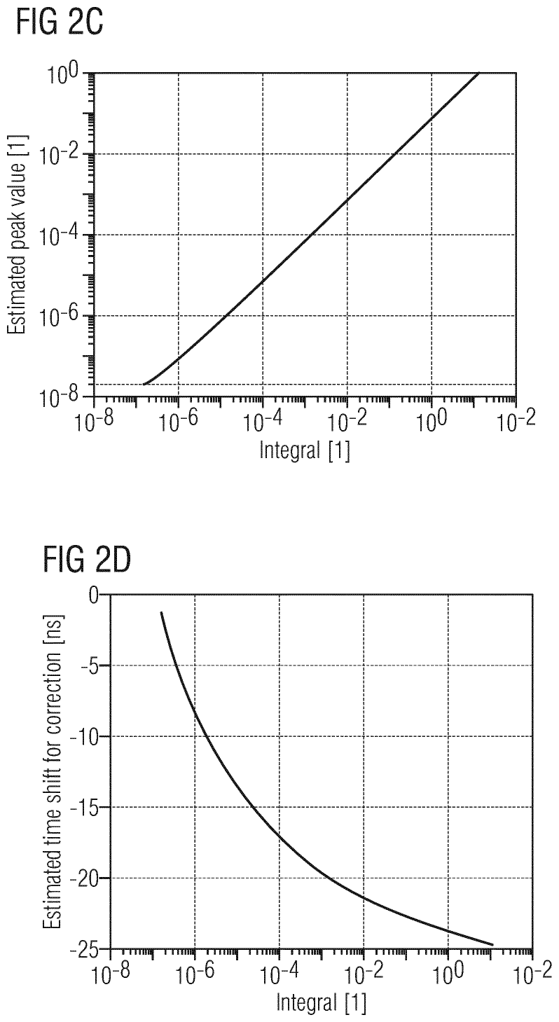

The time difference 120 between the trigger time, t(sₜₕ), and the time corresponding to the reference feature of the detected signal 104 may depend significantly on the peak value 122 of the detected signal 104. This dependence may result in a timing-error, which is referred as walk-error (and sometimes as black/white-error). FIG. 2A illustratively shows a dependence of the timing-error on a peak value of a signal. In this illustration, the predefined trigger threshold value, sₜₕ, is chosen as 0.2×10⁻⁷ in arbitrary units (e.g., normalized to a reference value). A plurality of signals 202, 204, 206, 208 may all have the same signal shape. A first signal 202 may have a peak value of 0.2×10⁻⁷ in arbitrary units (e.g., normalized) and there may be no offset between the peak value and the trigger time. A second signal 204 may have a peak value greater than the peak value of the first signal 202 and an offset between the peak value and the trigger time may be about 6 ns. A third signal 206 may have a peak value greater than the peak value of the second signal 204 and an offset between the peak value and the trigger time may be about 8 ns. A fourth signal 208 may have a peak value greater than the peak value of the third signal 206 and an offset between the peak value and the trigger time may be about 10 ns. The different offsets may represent the timing error (e.g., the walk-error). Illustratively, the plurality of signals 202, 204, 206, 208 may be located at the same temporal position, but may result in a different time measurement caused by the respective peak value. Hence, knowing the time offset may significantly improve the time measurement since the timing-error then can be compensated.

With reference to FIG. 1B, the processing circuit 108 processing circuit 108 may be configured to determine a compensated time measurement 130 (e.g., an error-compensated time measurement, e.g., a walk-error-compensated time measurement) associated with the detected signal 104 by adapting the determined time measurement 128 using the determined time difference 120.

In the following, a determination of the time difference 120 between the trigger time and the time corresponding to the reference feature of the detected signal 104 is described with reference to FIG. 2B. In this illustrative example, the reference feature of the detected signal 104 may be the peak value 122 of the detected signal 104. It is noted that any other reference feature (e.g., a half maximum) of the detected signal 104 may be used accordingly.

The processing circuit 108 may be configured to determine, for each peak value of a plurality of peak values of a signal having the expected properties, a respective first time offset between the trigger time, t(sₜₕ), and the time correspond to the peak value. For example, the signal having the expected properties may be scaled to have the respective peak value, a time corresponding to an intersection of the predefined trigger threshold value, sₜₕ, with the scaled signal may be determined, and a time difference between the determined time and the time corresponding to the peak value may be determined as respective first time offset (e.g., point “A” in FIG. 2B). Illustratively, the first time offsets may provide a first graph 212.

The processing circuit 108 may be configured to determine, for each peak value of the plurality of peak values of the signal having the expected properties, a respective second time offset such that a value of an integral of the signal from the respective second time offset to infinity is substantially equal to the generated integration value 114. For example, the signal having the expected properties may be scaled to have the respective peak value, a cumulated integral of the scaled signal may be determined, a respective trigger time may be determined such that the value of the integral of the signal from the respective trigger time to infinity is substantially equal to the generated integration value 114, and a time difference between the determined trigger time and the time corresponding to the peak value may be determined as respective second time offset (e.g., point “B” in FIG. 2B). Illustratively, the second time offsets may provide a second graph 214.

According to various aspects, the time offset corresponding to the peak value for which the first time offset is substantially equal to the second time offset may be determined as time difference 120. According to various aspects, the intersection between the first graph 212 and the second graph 214 may be determined graphically as time difference 120 (e.g., point “C” in FIG. 2B). According to various aspects, the processing circuit 108 may be configured to determine the time difference 120 and the peak value 122 of the detected signal 104.

According to various aspects, the detection system 100 may include or may be communicatively coupled to a memory device. The memory device may store a plurality of lookup-tables, such as a first lookup-table, a second lookup-table, and/or a third lookup-table. Each lookup-table of the plurality of lookup-tables may be associated with a respective trigger threshold value and may be generated based on a plurality of integration values (e.g., as described with reference to FIG. 2B).

According to various aspects, the first lookup-table may be associated with the predefined trigger threshold value, sₜₕ, and may include a respective energy for each integration value of a plurality of integration values. The processing circuit 108 may be configured to determine the energy of the detected signal 104 using the generated integration value 114 and the first lookup-table.

According to various aspects, the second lookup-table may be associated with the predefined trigger threshold value, sₜₕ, and may include a respective peak value for each integration value of a plurality of integration values. The processing circuit 108 may be configured to determine the peak value 122 of the detected signal 104 using the generated integration value 114 and the second lookup-table. An exemplary graphical representation of the second lookup-table is shown in FIG. 2C.

According to various aspects, the third lookup-table may be associated with the predefined trigger threshold value, sₜₕ, and may include a respective time difference for each integration value of a plurality of integration values. The processing circuit 108 may be configured to determine the time difference 120 of the detected signal 104 using the generated integration value 114 and the third lookup-table. An exemplary graphical representation of the third lookup-table is shown in FIG. 2D.

According to various aspects, a lookup-table as described herein (e.g., the first lookup-table, e.g., the second lookup-table, e.g., the third lookup-table) may be implemented in an analog domain or a value-continuous domain by representing, e.g. by approximating, the relationship between the plurality of integration values and the respective characteristic (e.g., may provide the graphical representation of the respective lookup-table, such as one of the exemplary representations shown in FIG. 2C and FIG. 2D). For example, an analog circuit may be configured to map each of the plurality of integration values to a value of the respective characteristic. For example, a processor may apply an approximation function (e.g., an n-th order approximation), which represents the relationship between the plurality of integration values and the respective characteristic.

According to various aspects, the time measurement 128 may be a time-of-flight measurement. In this case, the time measurement start signal 126 may be a time-of-flight start signal indicating a start of an emission of an emitted signal. The detector circuit 102 may be configured to detect a delayed and modified version of the emitted signal (e.g., a delayed, attenuated and noisy version of the emitted signal) and to provide the detected delayed and modified version of the emitted signal as the detected signal 104. According to various aspects, the processing circuit 108 may be configured to determine a time-of-flight as the time between the time-of-flight start signal and the trigger time, t(sₜₕ). The processing circuit 108 may be further configured to determine a compensated time-of-flight (e.g., a walk-error compensated time-of-flight) by adapting the determined time-of-flight using the determined time difference 120.

With reference to FIG. 1C, the detection system 100 may include a delay circuit 131. The delay circuit 131 may be configured to delay the detected signal 104 by a predefined time delay (e.g., in the range from 0.1 ns to 200 ns). According to various aspects, the integrator circuit 106 may be configured to integrate the delayed signal responsive to the integration start signal 112. The delay circuit 131 may be employed to compensate a time delay caused by the processing circuit 108 (e.g., to synchronize a detection of the change of the detection of the detected signal 104 and a start of integration of the detected signal 104 by the integrator circuit 106).

With reference to FIG. 1D, the processing circuit 108 may include a trigger comparator 132. The trigger comparator 132 may be configured to output 134 a first trigger signal in the case that a value of the detected signal 104 is greater than the predefined trigger threshold value, sₜₕ, and to output 134 a second trigger signal in the case that a value of the detected signal 104 is less than the predefined trigger threshold value, sₜₕ. The change of the detected signal 104 may correspond to a change of the output 134 of the trigger comparator 132 from the second trigger signal to the first trigger signal, or vice versa. Illustratively, the change of the output 134 may be or may represent the trigger signal 110. According to various aspects, the processing circuit 108 may include a control logic

136. The control logic 136 may be configured to detect the change of the output 134 of the trigger comparator 132 (e.g., from the second trigger signal to the first trigger signal, e.g., from the first trigger signal to the second trigger signal). The control logic 136 may be configured to, in the case that the change the output 134 of the trigger comparator 132 from the second trigger signal to the first trigger signal is detected, transmit the integration start signal 112 to the integrator circuit 106.

With reference to FIG. 1E, the integrator circuit 106 may include an integrator 142. The integrator 142 may be configured to integrate the detected signal 104 responsive to the integration start signal 112.

According to various aspects, the processing circuit 108 may be configured to transmit a clear signal (in some aspects referred to as integration reset signal) to the integrator 142. The integrator 142 may be configured to set (e.g., to clear) a present integration value to a predefined reset value (e.g., a value substantially equal to “0”).

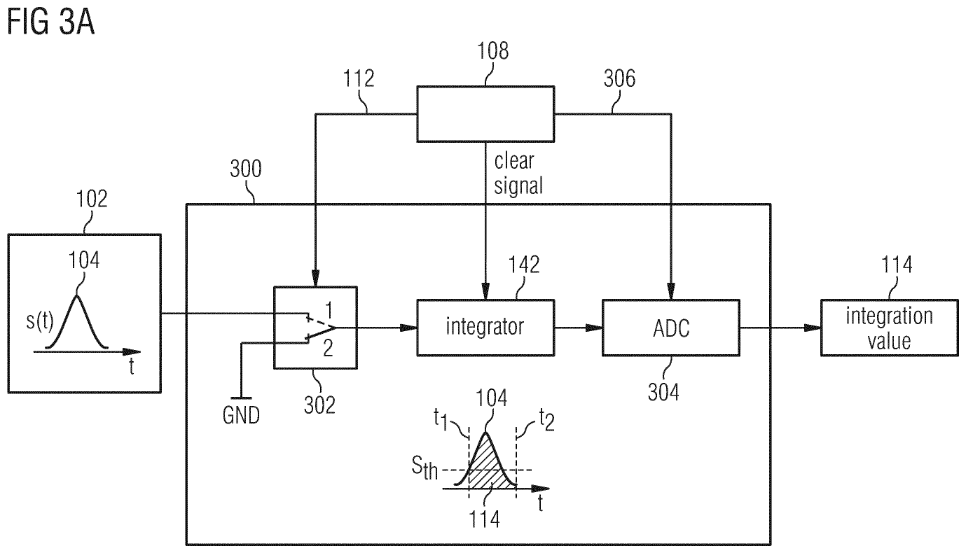

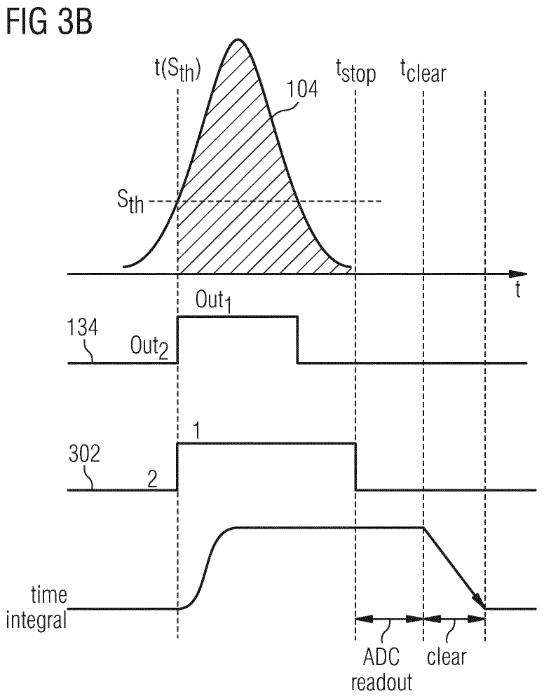

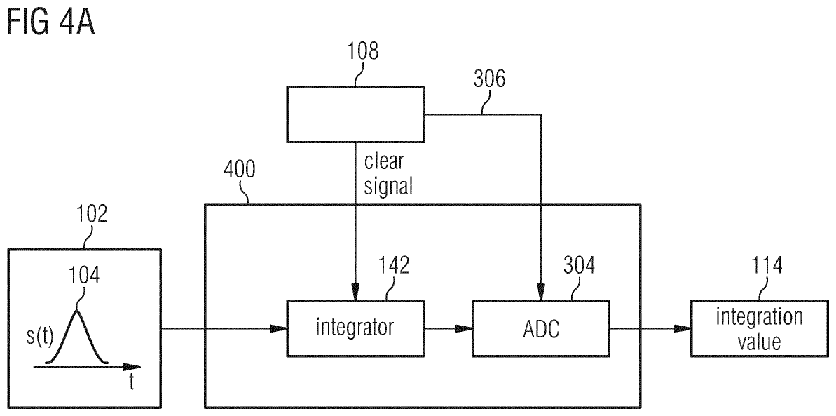

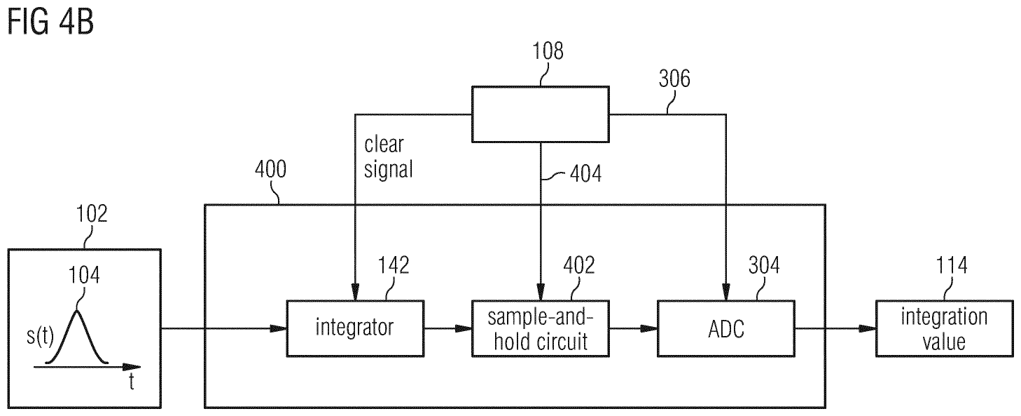

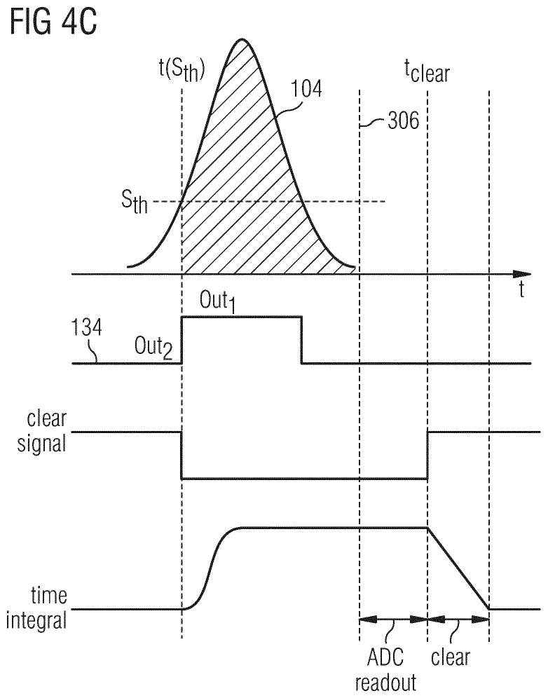

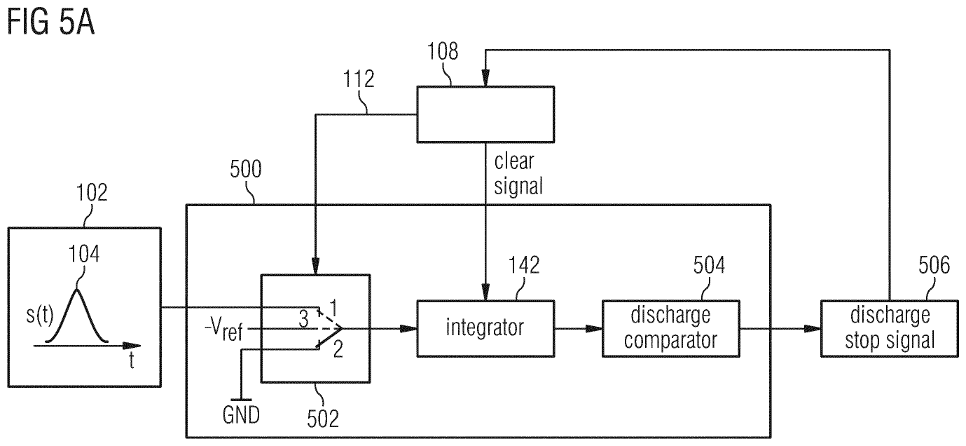

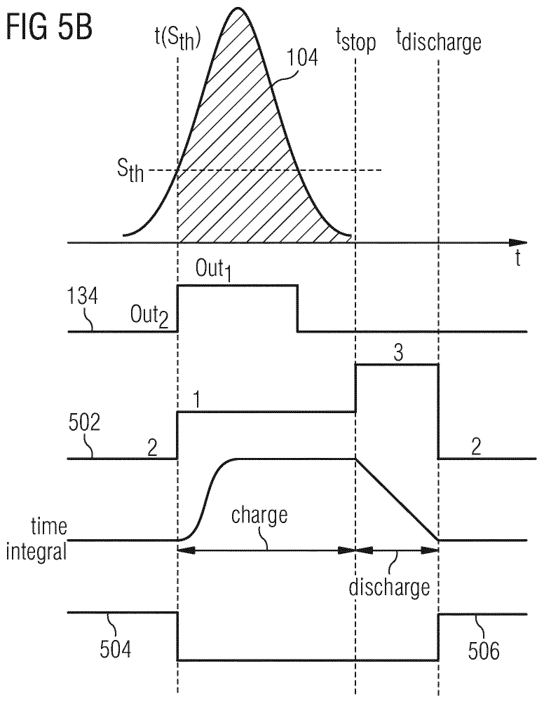

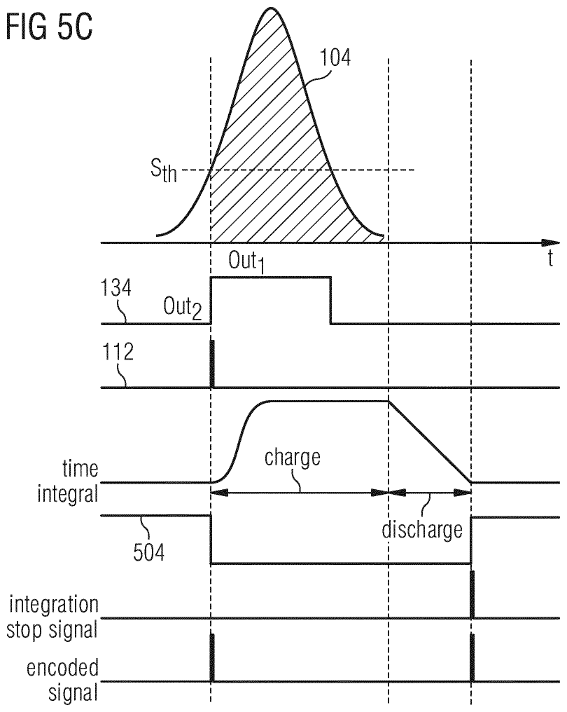

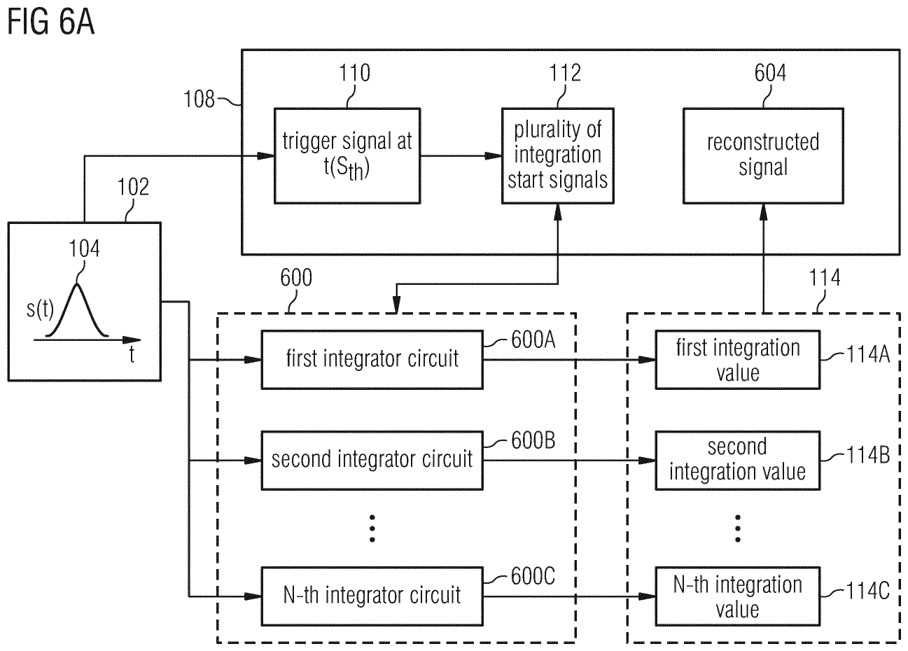

In the following, various configurations of the integrator circuit 106 including the integrator 142 are described with reference to FIG. 3A to FIG. 7.

FIG. 3A shows an integrator circuit 300 according to various aspects. The integrator circuit 300 may include the integrator 142. The integrator 142 may be an operational amplifier integrator (e.g., an operational amplifier with a capacitor). The integrator 142 may be configured to output an analog output value representing the integration value. The integrator circuit 300 may include an analog-to-digital-converter (ADC) 304. The ADC 304 may be configured to detect the analog output value of the integrator 142 and to output a digital representation of the generated integration value 114. The ADC 304 may be configured to output the generated integration value 114 responsive to an ADC readout signal 306 (e.g., the integration stop signal).

The integrator circuit 300 may include an input switch 302. The input switch 302 may have a first state 1 and a second state 2. The input switch 302 may be configured to switch to the first state 1 responsive to the integration start signal 112 (e.g., at time t₁). The input switch 302 may be configured to switch to the second state 2 responsive to the integration stop signal (e.g., at time t₂). The integrator 142 may be configured to integrate the detected signal 104 in the case that the input switch 302 is in the first state 1 and to not integrate the detected signal 104 in the case that the input switch 302 is in the second state 2. According to various aspects, the second state 2 of the input switch 302 may be connected to ground (e.g., a ground voltage).

FIG. 3B shows an exemplary timing diagram associated with the integrator circuit 300. At the trigger time, t(sₜₕ), the output 134 of the trigger comparator 132 may change from the second trigger signal (Out₂) to the first trigger signal (Out₁). Responsive to the integration start signal 112, the input switch 302 may change from the second state 2 to the first state 1 and the integrator 142 may start to integrate the detected signal 104. Responsive to the integration stop signal at a time tₛₜₒₚ, the input switch 302 may change from the first state 1 to the second state 2 and the integrator 142 may stop to integrate the detected signal 104. Responsive to the ADC readout signal 306, the ADC 304 may generate a digital integration value as the integration value 114. According to various aspects, responsive to the clear signal applied at a time t_{clear}, the integrator 142 may be reset to the predefined reset value (e.g., a value substantially equal to “0”).

FIG. 4A shows an integrator circuit 400 according to various aspects. The integrator circuit 400 may include the integrator 142 and the ADC 304. The processing circuit 108 may be configured to transmit the integration start signal 112 to the integrator 142 by not applying the clear signal to the integrator 142. According to various aspects, the integrator 142 may be configured to integrate the detected signal 104 in the case that the clear signal is not applied. Illustratively, the processing circuit 108 may apply the clear signal to the integrator 142 as long as no trigger signal 110 is detected and may stop applying the clear signal responsive to detecting the trigger signal 110. This may represent a transmission of the integration start signal 112.

According to various aspects, the integrator circuit 400 may include a sample-and-hold circuit 402 (see FIG. 4B). The sample- and-hold circuit 402 may be configured to sample the output of the integrator 142 and to hold the sampled output substantially constant. The sample-and-hold circuit 402 may be configured to sample the output of the integrator 142 and to hold the sampled output substantially constant responsive to a sample-and-hold signal 404. The processing circuit 108 may be configured to transmit the sample-and-hold signal 404 to the sample-and-hold circuit 402. The ADC 304 may be configured to detect the hold output of the sample-and-hold circuit 402 and to output a (e.g., digital) representation of the hold output as the generated integration value 114.

FIG. 4C shows an exemplary timing diagram associated with the integrator circuit 400. At the trigger time, t(sₜₕ), the output 134 of the trigger comparator 132 may change from the second trigger signal (Out₂) to the first trigger signal (Out₁). The processing circuit 108 may stop applying the clear signal at the trigger time, t(sₜₕ) and the integrator 142 may start to integrate the detected signal 104. Responsive to the ADC readout signal 306, the ADC 304 may generate the integration value 114.

According to various aspects, the processing circuit 108 may again apply the clear signal at a time t_{clear} until another change of the output 134 of the trigger comparator 132 from the second trigger signal (Out₂) to the first trigger signal (Out₁) is detected.

FIG. 5A shows an integrator circuit 500 according to various aspects. The integrator circuit 500 may include the integrator 142. The integrator circuit 500 may include an input switch 502. The input switch 502 may have at least a charge state 1 and a discharge state 3. According to various aspects, the input switch 502 may have the charge state 1, a stop state 2 (e.g., configured similar to the second state 2 of the input switch 302), and the discharge state 3. The input switch 502 may be configured to switch to the charge state 1 responsive to the integration start signal 112. The input switch 502 may be configured to switch to the discharge state 3 responsive to the integration stop signal. The integrator 142 may be configured to be charged by integrating the detected signal 104 in the case that the input switch 502 is in the charge state 1. The integrator 142 may be configured to be discharged in the case that the input switch 502 is in the discharge state 3. In the discharge state 3 of the input switch 502, the integrator 142 may be electrically conductively connected to a reference value (e.g., a reference voltage V_{ref}, e.g., a reference current) via the input switch 502.

The integrator circuit 500 may include a discharge comparator 504. The discharge comparator 504 may be configured to output a first discharge signal in the case that a charge of the integrator 142 is greater than a predefined discharge threshold value (e.g., substantially zero) and to output a second discharge signal in the case that a charge of the integrator 142 is less than the predefined discharge threshold value. For example, the predefined discharge threshold value may be a predefined discharge threshold voltage value or a predefined discharge threshold current value. According to various aspects, the processing circuit 108 may be configured to detect a change of the discharge signal of the discharge comparator 504 from the first discharge signal to the second discharge signal (e.g., as a discharge stop signal 506).

According to various aspects, the processing circuit 108 may be configured to transmit the integration stop signal a predefined time period after transmitting the integration start signal 112. The processing circuit 108 may be configured to determine the generated integration value 114 using a time duration between the integration start signal and the discharge stop signal 506.

The processing circuit 108 may be configured to determine the generated integration value 114 using a time duration between the integration stop signal and the discharge stop signal 506.

FIG. 5B shows an exemplary timing diagram associated with the integrator circuit 500. At the trigger time, t(sₜₕ), the output 134 of the trigger comparator 132 may change from the second trigger signal (Out₂) to the first trigger signal (Out₁), providing the integration start signal 112. Responsive to the integration start signal 112, the input switch 502 may change from the stop state 2 to the charge state 1 and the integrator 142 may start to integrate the detected signal 104. After the predefined time period, the processing circuit 108 may transmit the integration stop signal at a time tₛₜₒₚ. Responsive to the integration stop signal, the input switch 502 may change from the charge state 1 to the discharge state 3 and the integrator 142 may be discharged. Once the charge of the integrator 142 falls below the predefined discharge threshold value, the discharge comparator 504 may provide the discharge stop signal 506 at a time t_{discharge}. According to various aspects, the input switch 502 may change from the discharge state 3 to the stop state 2 at the time t_{discharge}.

According to various aspects, the processing circuit 108 may be configured to determine a time duration it takes to discharge the integrator 142 (e.g., a capacitor of the integrator 142) and to determine the generated integration value 114 using determined time duration. For example, the detection system 100 may include the clock signal generator and the processing circuit 108 may be configured to determine the time duration as an integer number of clock cycles between the integration stop signal and the discharge stop signal 506 and/or an integer number of clock cycles between the integration start signal 112, the discharge stop signal 506, and the time of the predefined time period.

FIG. 5C shows, in addition to the timing diagram of FIG. 5B, the integration start signal 112 and the integration stop signal. According to various aspects, the processing circuit 108 may be configured to combine the integration start signal 112 and the integration stop signal to a single binary signal. For example, the processing circuit 108 may be configured to generate an encoded signal by combining (e.g., merging) the integration start signal 112 and the integration stop signal. For example, in the case of analogous signals, the integration start signal 112 and the integration stop signal may be summed up to the encoded signal. For example, in the case of digital signals, the integration start signal 112 and the integration stop signal may be combined by an “OR”-operation to the encoded signal. The encoded signal may facilitate: an intermediate storage of the signal (e.g., using a delay line), to digitally transmit the signal to another circuit for further processing (e.g., the time-of-flight and/or at least one characteristic of the one or more characteristics 116 may be determined by the other circuit), etc.

FIG. 6A shows an integrator circuit 600 according to various aspects. The integrator circuit 600 may include a plurality of integrator circuits 600A, 600B, 600C. Each integrator circuit of the plurality of integrator circuits 600A, 600B, 600C may be configured in accordance with one of the integrator circuit 300, the integrator circuit 400, or the integrator circuit 500. The plurality of integrator circuits 600A, 600B, 600C may include a number of “N” integrator circuits with “N” being any integer number equal to or greater than one (e.g., equal to or greater than two).

According to various aspects, the processing circuit 108 may be configured to transmit a respective integration start signal 112 to each integrator circuit of the plurality of integrator circuits 600A, 600B, 600C to initiate the integration of the detected signal 104 at a respective time that is different from the time of the other integrator circuit of the plurality of integrator circuits 600A, 600B, 600C. For example, the processing circuit 108 may be configured to transmit the respective integration start signal 112 to each integrator circuit of the plurality of integrator circuits 600A, 600B, 600C one after another based on a respective predefined time difference between two consecutively transmitted integration start signals 112. Illustratively, the processing circuit 108 may transmit a plurality of integration start signals 112 to the integrator circuit 600.

FIG. 6B shows an exemplary timing diagram associated with the integrator circuit 600 for N=5. The first integrator circuit 600A may start to integrate the detected signal 104 at a first time t₁ (first time integral), the second integrator circuit 600B may start to integrate the detected signal 104 a predefined time period after the first time at a second time t₂ (second time integral), the third integrator circuit may start to integrate the detected signal 104 a predefined time period after the second time at a third time t₃ (third time integral), the fourth integrator circuit may start to integrate the detected signal 104 a predefined time period after the third time at a fourth time t₄ (fourth time integral), and the fifth integrator circuit may start to integrate the detected signal 104 a predefined time period after the fourth time at a fifth time t₅(third time integral). According to various aspects, each integrator circuit may be configured to stop integrating the detected signal responsive to the integration stop signal at a time tₛₜₒₚ.

FIG. 6C shows exemplary diagrams associated with the integrator circuit 600 for N=7. In this example, each of the N=7 integrator circuits may be configured to in accordance with the integrator circuit 500. The diagram 610 illustrates an exemplary detected signal 104 and the predefined trigger threshold value sₜₕ. Each of the N=7 integrator circuits may receive a respective integration start signal 112 at a corresponding time t₁ . . . t₇. Responsive to the integration stop signal at the time tₛₜₒₚ, each of the N=7 integrator circuits may be discharged as described with reference to the integrator circuit 500 (see diagram 620). Each of the N=7 integrator circuits may be configured to output a respective discharge stop signal 506. The discharge stop signals 506 generated by the N=7 integrator circuits are shown in the diagram 630. According to various aspects, the trigger signal 110 and the discharge stop signals 506 generated by the N=7 integrator circuits may be combined to an encoded signal (see diagram 640).

According to various aspects, a respective integration value 114 may be generated for each of the N=7 integrator circuits. The processing circuit 108 may be configured to reconstruct a shape of the detected signal 104 using the integration values generated by the N=7 integrator circuits, as exemplarily shown in diagram 650. Illustratively, the detection system 100 may employ a plurality of integrator circuits to reconstruct the shape of the detected signal 104. Thus, the detection system 100 may be capable to use a TDC-based approach and to still determine information about the shape of the detected signal 104.

According to various aspects, the processing circuit 108 may be configured to transmit the integration start signal 112 to each integrator circuit of the plurality of integrator circuits 600A, 600B, 600C substantially at the same time to initiate the integration of the detected signal 104. In this case, the processing circuit 108 may be configured to transmit a respective integration stop signal to each integrator circuit of the plurality of integrator circuits 600A, 600B, 600C at a respective time that is different from the time of the other integrator circuit of the plurality of integrator circuits 600A, 600B, 600C. According to various aspects, the integration of the plurality of integrator circuits 600A, 600B, 600C may be initiated at the same time and the integration may be stopped at different times. According to various aspects, the respective integration of each integrator circuit of the plurality of integrator circuits 600A, 600B, 600C may be initiated at a time that is different from the time of the other integrator circuit of the plurality of integrator circuits 600A, 600B, 600C and/or the respective integration of each integrator circuit of the plurality of integrator circuits 600A, 600B, 600C may be stopped at a time that is different from the time of the other integrator circuit of the plurality of integrator circuits 600A, 600B, 600C.

FIG. 7 shows an exemplary integrator circuit 600 for N=2 including a first integrator circuit 700A and a second integrator circuit 700B. The first integrator circuit 700A may be configured to integrate the detected signal 104 responsive to a first integration start signal 112A and to generated a first integration value 114A. The second integrator circuit 700B may be configured to integrate the detected signal 104 responsive to a second integration start signal 112B and to generated a second integration value 114B. The processing circuit 108 may be configured to determine a respective time difference 120 for each of the first integrator circuit 700A and the second integrator circuit 700B, described herein. The processing circuit 108 may be configured to determine a first time difference 120A associated with the generated first integration value 114A and a second time difference 120B associated with the generated second integration value 114B using the expected properties of the detected signal 104. The processing circuit 108 may be configured to compare the first time difference 120A and the second time difference 120B. According to various aspects, the processing circuit 108 may be configured to determine of a confidence 702 of the expected properties of the detected signal 104 based on the comparison of the first time difference 120A and the second time difference 120B. For example, the processing circuit 108 may be configured to determine whether an absolute value of a difference between the first time difference 120A and the second time difference 120B is less than a predefined time difference verification threshold value. The processing circuit 108 may be configured to determine, in the case that the absolute value of the difference between the first time difference 120A and the second time difference 120B is less than the predefined time difference verification threshold value, that the detected signal 104 has the expected properties. Illustratively, the processing circuit 108 may confirm the expected properties of the detected signal 104. The processing circuit 108 may be configured to verify, in the case that the absolute value of the difference between the first time difference 120A and the second time difference 120B is less than the predefined time difference verification threshold value, the expected properties of the detected signal 104 as properties of the detected signal 104.

According to various aspects, the processing circuit 108 may be configured to determine a first peak value of the detected signal 104 using the first integration value 114A and the expected properties of the detected signal 104. The processing circuit 108 may be configured to determine a second peak value of the detected signal 104 using the second integration value 114B and the expected properties of the detected signal 104. The processing circuit 108 may be configured to determine whether an absolute value of a difference between the first peak value and the second peak value is less than a predefined peak verification threshold value. The processing circuit 108 may be configured to determine, in the case that the absolute value of the difference between the first peak value and the second peak value is less than the predefined peak verification threshold value, that the detected signal 104 has the expected properties.

According to various aspects, the processing circuit 108 may be configured to verify the expected properties of the detected signal 104 as properties of the detected signal 104 in the case that the absolute value of the difference between the first time difference 120A and the second time difference 120B is less than the predefined time difference verification threshold value and that that the absolute value of the difference between the first peak value and the second peak value is less than the predefined peak verification threshold value.

According to various aspects, the processing circuit 108 may be configured to determine a first energy of the detected signal 104 using the first integration value 114A and the expected properties of the detected signal 104. The processing circuit 108 may be configured to determine a second energy value of the detected signal 104 using the second integration value 114B and the expected properties of the detected signal 104. The processing circuit 108 may be configured to determine whether an absolute value of a difference between the first energy value and the second energy value is less than a predefined energy verification threshold value. The processing circuit 108 may be configured to determine, in the case that the absolute value of the difference between the first energy value and the second energy value is less than the predefined energy verification threshold value, that the detected signal 104 has the expected properties. According to various aspects, the processing circuit 108 may be configured to verify the expected properties of the detected signal 104 as properties of the detected signal 104 in the case that the absolute value of the difference between the first time difference 120A and the second time difference 120B is less than the predefined time difference verification threshold value, that that the absolute value of the difference between the first peak value and the second peak value is less than the predefined peak verification threshold value, and/or that that the absolute value of the difference between the first energy value and the second energy value is less than the predefined energy verification threshold value.

As described herein, each configuration 300, 400, 500, 600, 700 of the integrator circuit 106 may be realized with a low number of components, a low system complexity, and/or low cost while still capable to perform highs-speed implementations. The proposed architecture allows for a low-complexity and cost-effective implementation (particularly as compared to full waveform sampling solutions using high-speed ADCs). The solution may be implemented taking into account practical aspects like splitting the TDC into a coarse and fine stage that is suitable for implementations using FPGAs known in the art. In some aspects, the adapted TDC-approach can be combined with correlation receiver concepts allowing for a more robust signal detection (e.g., in the presence of strong background noise). Multi-hit capabilities can be added.

The detection system 100 described herein may be a light detection system. In this case, the detected signal may be or may include a light signal.

According to various aspects, the light detection system may be a light detection and ranging (LIDAR) system.

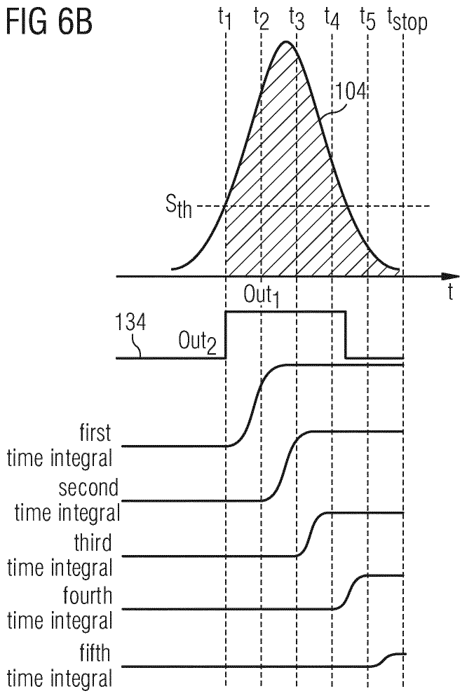

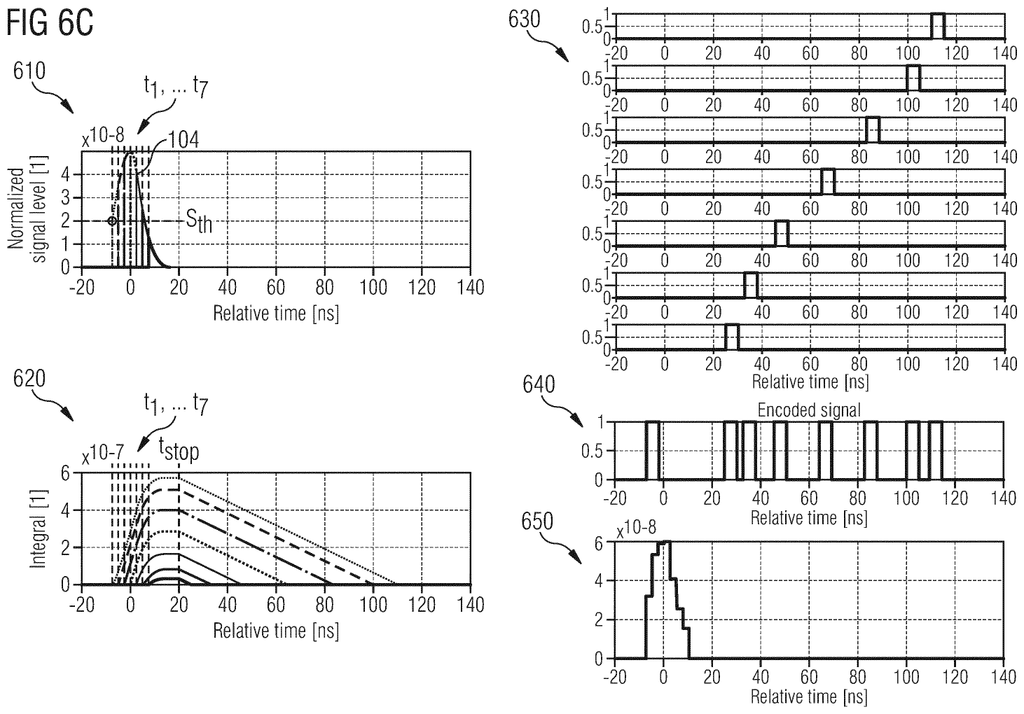

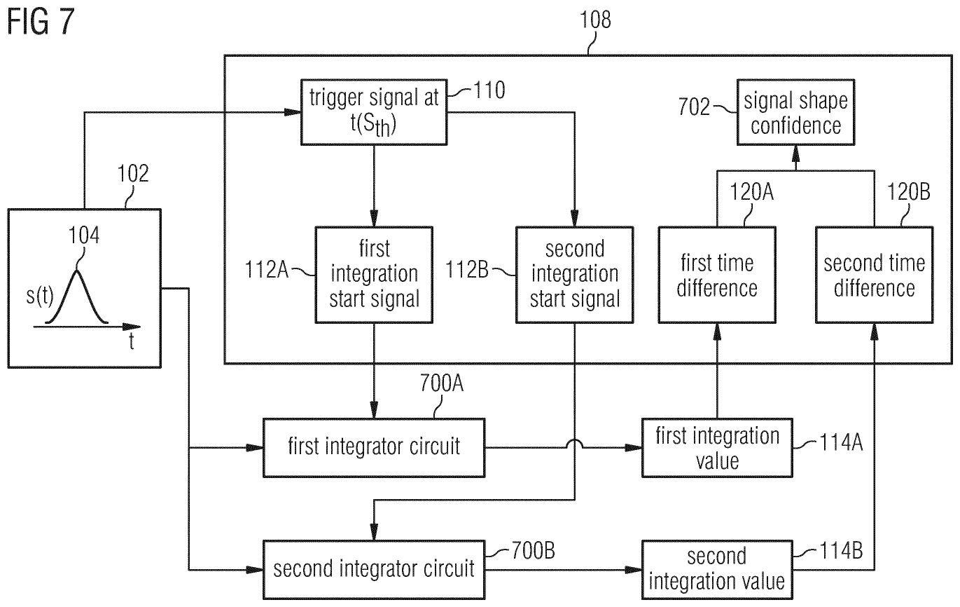

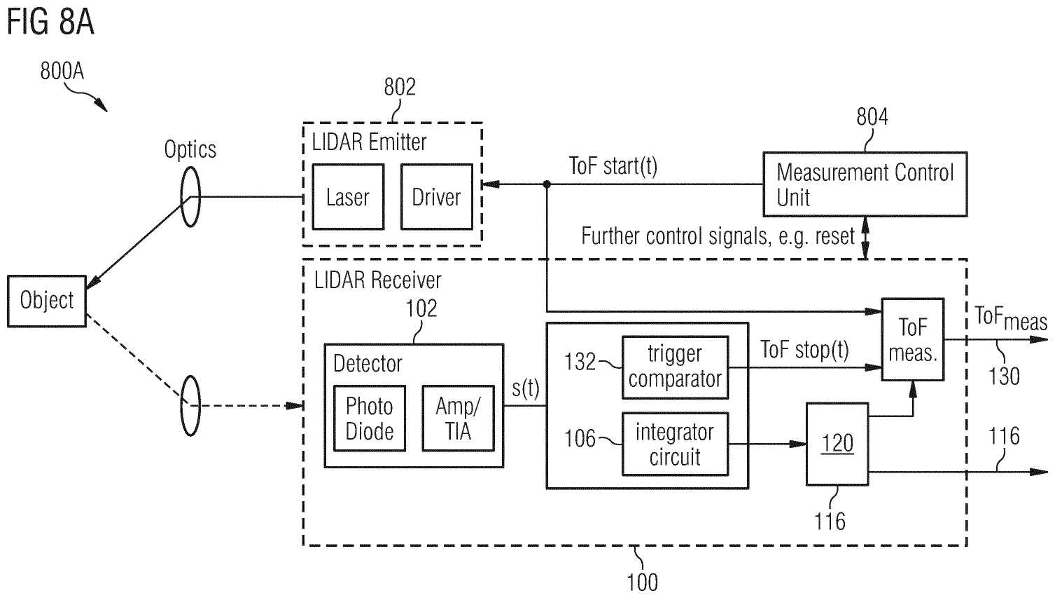

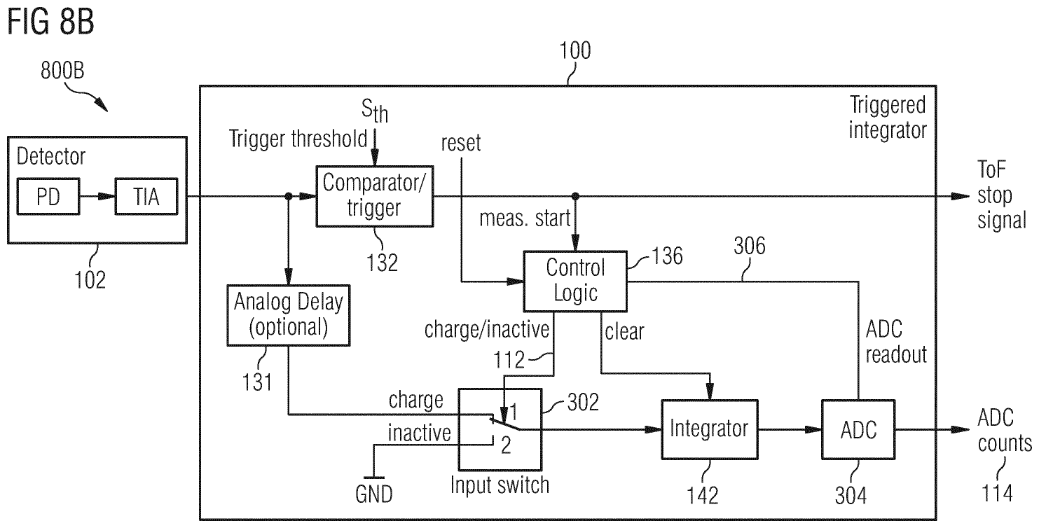

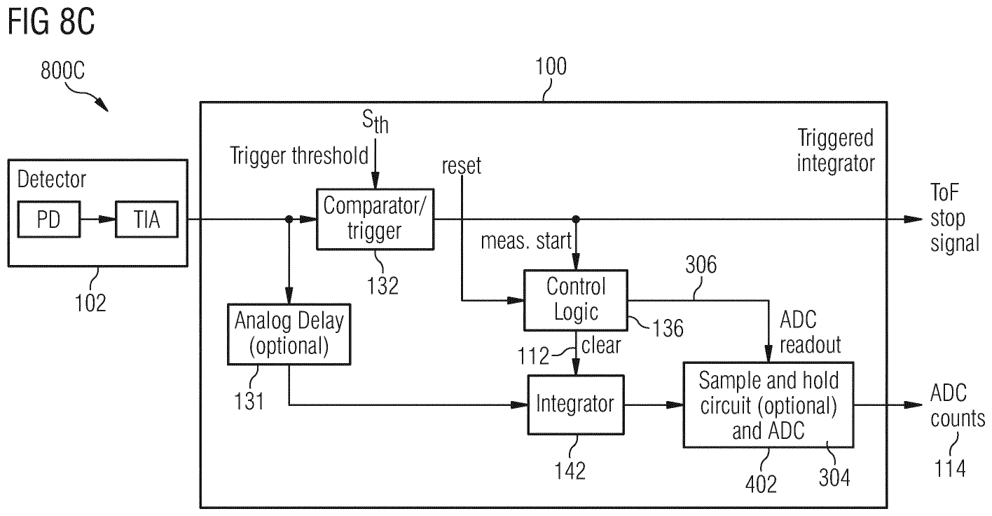

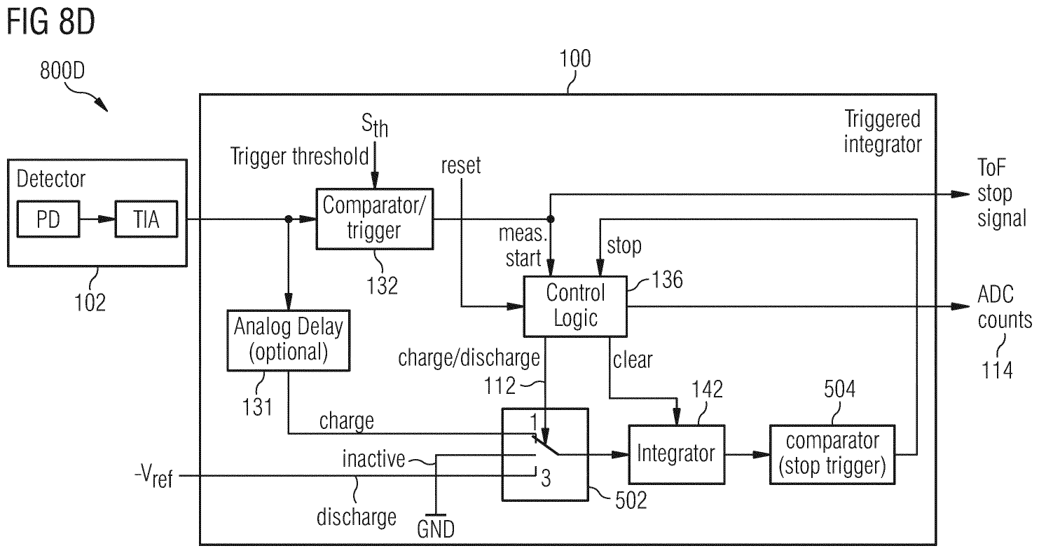

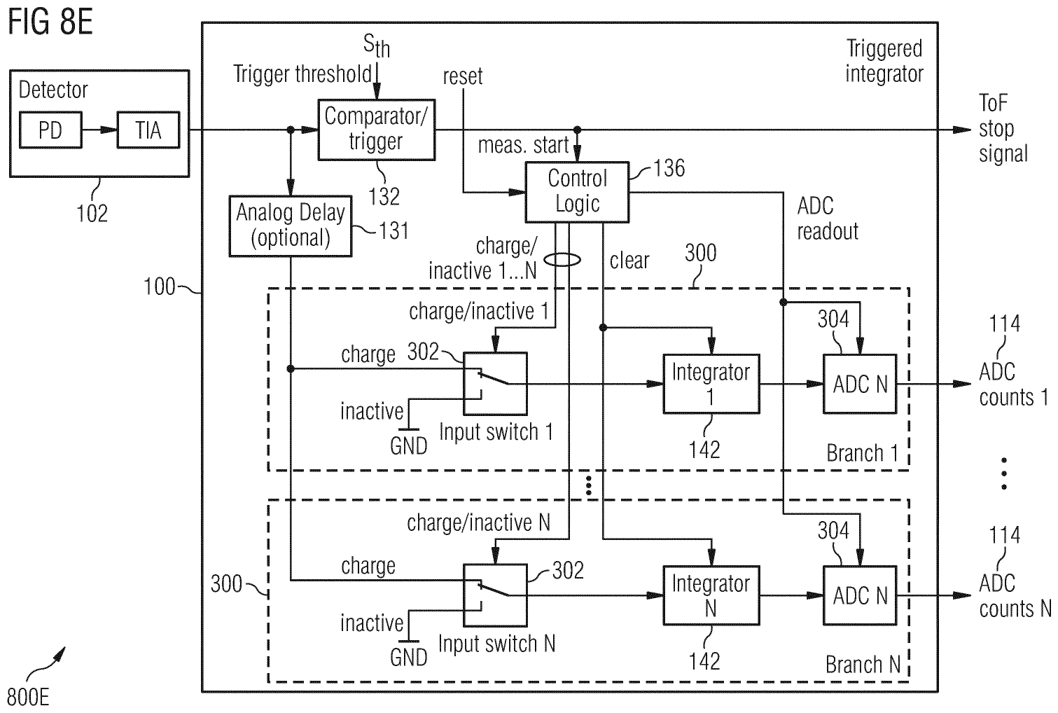

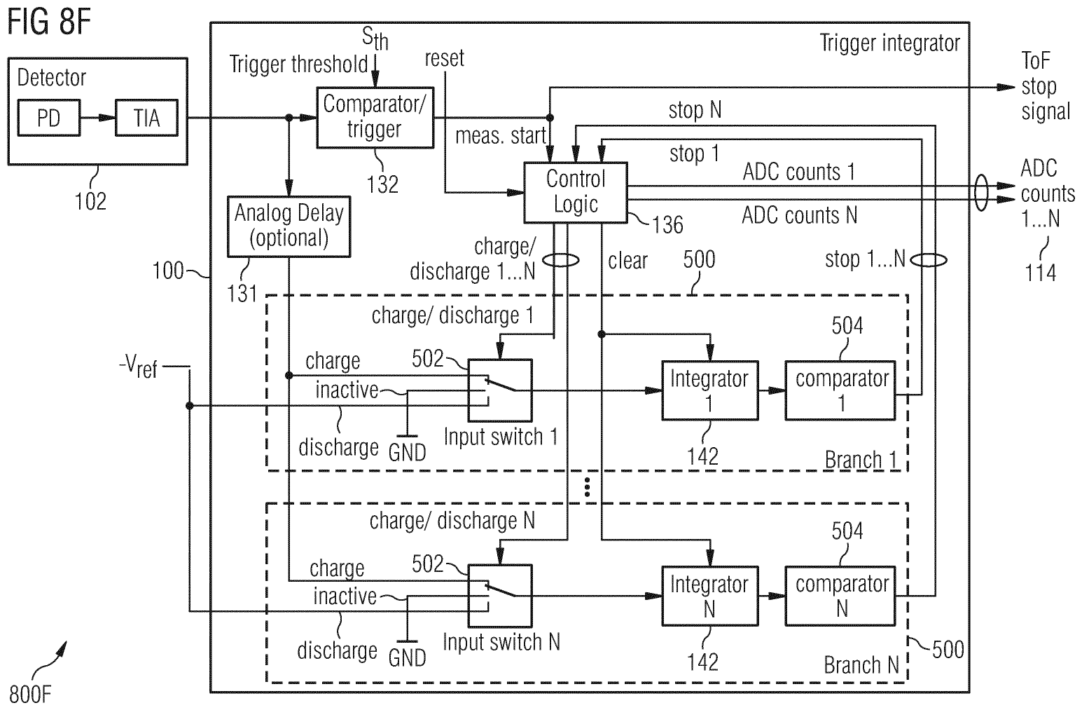

FIG. 8A to FIG. 8F each shows a LIDAR system 800A, 800B, 800C, 800D, 800E, 800F according to various aspects.

Each LIDAR system 800A, 800B, 800C, 800D, 800E, 800F may include a LIDAR Receiver configured in accordance with the detection system 100. The detector circuit 102 may include at least one photodiode. The at least one photodiode may be configured to detect a light signal. The at least one photodiode may be configured to generate an analog signal representing the detected light signal (e.g., in response to a light signal impinging onto the at least one photodiode). The at least one photodiode may be or may include at least one of a PIN photodiode, an avalanche photodiode, or a silicon photomultiplier. The detector circuit 102 may further include an amplifier (Amp). The amplifier may be configured to amplify the analog signal generated by the at least one photodiode.

According to various aspects, the analog signal generated by the at least one photodiode may be an analog signal of a first type and the amplifier may be configured to convert the analog signal of the first type into an analog signal of a second type different from the first type. For example, the analog signal of the first type may be a current and the analog signal of the second type may be a voltage, or vice versa. According to various aspects, the amplifier may be a transimpedance amplifier (TIA).

With reference to FIG. 8A, the LIDAR system 800A may further include a light emission system 802 (e.g., a LIDAR emitter). The light emission system 802 may be configured to emit a light signal.

The light emission system 802 may be configured to emit a light signal, e.g. a light signal including one or more light pulses. The light emission system 802 may include a light source configured to emit light having a predefined wavelength, for example in the infra-red and/or near infra-red range, such as in the range from about 700 nm to about 5000 nm, for example in the range from about 860 nm to about 1600 nm, or for example at 905 nm or 1550 nm. The light source may be configured to emit light in a pulsed manner, for example the light source may be configured to emit one or more light pulses (e.g., a sequence of light pulses). In some aspects, the light source may include an optoelectronic light source (e.g., a laser source). As an example, the light source may include one or more light emitting diodes. As another example the light source may include one or more laser diodes, e.g. one or more edge-emitting laser diodes or one or more vertical cavity surface emitting laser diodes. The light source may be configured to emit one or more laser pulses, e.g. a sequence of laser pulses. The light emission system may include a light source driver (e.g., an electronic driver circuit) configured to control an emission of light by the light source. The light source driver may be configured to provide a driving signal to the light source to prompt (e.g., to trigger, or to start) an emission of light by the light source.

In some aspects, data may be encoded in an emitted light signal. The light source driver may be configured to control an emission of light by the light source to encode data in the emitted light, e.g. according to a data communication protocol. Data communication protocols may be formulated that use information in the signal level and/or the pulse-shape to encode data (e.g. ID information, data traffic, or signaling messages) in addition to the LIDAR ranging signals. The task of the light emission system 802 (also referred to herein as emitter) may be understood as providing an optical output pulse with the desired properties. Among others, the output pulse duration, the pulse peak power, and the pulse shape may be adapted for LIDAR applications. In some aspects, the LIDAR system 800A may include the clock signal generator configured to generate a clock signal. As an example, the clock signal generator may include an oscillator and one or more phase-locked loops. The clock signal generator may be configured to provide a common clock signal to the light emission system 802 and the light detection system 100. The light source driver may be configured to control the emission of light by the light source in accordance (e.g., in synchronization) with the common clock signal. This may provide a synchronized operation of light emission and detection, and a time measurement (e.g., of the time-of-flight) of the emitted light signal. In some aspects, the light source driver may be configured to receive a start signal, ToF start(t), indicating that emission of light should be initiated. The light source driver may receive the start signal from a circuit or module external to the light emission system 802, e.g. from a measurement control circuit of the LIDAR system 800A. The light source driver may be configured to control the light emission by the light source in response to the start signal received at the light source driver. The start signal may be synchronized with the common clock signal. Only as an example a rising edge of the start signal may be synchronized with a rising edge of the common clock signal. Illustratively, the driver may be triggered from the outside by an electric signal that allows for a synchronized emission of the optical output pulse.

In some aspects, the one or more characteristics 116 (e.g., a time difference, an energy, a peak value, a confidence of expected properties of the detected light signal) provided by the light detection system 100 may provide for a dynamic adaptation of the ranging schemes implemented in the LIDAR system 800A. For example, the availability of the peak value makes it possible to flexibly react based on measurements of the environmental conditions. It may be possible to adjust system settings over time and be adaptive. This may improve the system performance, e.g. the power efficiency, or may render the system more versatile and thus robust in a variety of situations.

The light source driver may be configured to control the light emission by the light source in accordance with the one or more characteristics 116 (e.g., a time difference, an energy, a peak value, a confidence of expected properties of the detected light signal). As an example, the light source driver may be configured to control the light source to emit a further light signal having increased optical power in case the peak value of the detected light signal is less than a predefined threshold value (or with reduced optical power in case the peak value is above another threshold). This configuration may ensure that safety requirements are fulfilled, while ensuring sufficient optical power for detecting objects (e.g., obstacles) in a field of view. Illustratively, a peak value-dependent power control may be implemented. The light emission system 802 may start with a configuration where not the full optical power is emitted (e.g., to provide an overview shot). After identifying areas in the field of view which have a low received signal strength (low peak value), the power may be increased for these areas in the field of view to obtain better results for the next measurement. This adaptive approach may provide more flexible trade-offs of range/signal integrity versus power consumption/eye safety.

As another example, the processing circuit of the light detection system may be configured to adapt a number of signal averaging cycles based on the peak value information. Illustratively, a peak value-dependent signal averaging may be provided. The peak value-information may be used to adjust the number of signal averaging cycles at the detector that is used to improve the signal-to-noise ratio. A trade-off may be provided between range/signal integrity versus refresh rate.

As a further example, the light emission system 802 may be configured to control an emission direction of the light based on the peak value information. The light emission system 802 may include a beam steering element (e.g., a liquid crystal polarization grating, LCPG), and may be configured to control the beam steering element in accordance with the peak value information. Illustratively, peak value-dependent coarse beam steering (LCPG control) may be provided. The information about the received peak value may be used to adjust the coarse scanning pattern, e.g. as used in LCPG-based systems. A trade-off may be provided between range/signal integrity versus field of view coverage.

In a similar manner, the expected properties (e.g., the shape) of the detected light signal (e.g., the pulse-shape) may be used to further analyze the environmental conditions or the current target object to adjust system settings over time and be adaptive. This may improve system performance, e.g. power efficiency, or may make the system more versatile and thus robust in a variety of situations.

It is understood that the aspects described with reference to FIG. 8A to FIG. 8F also apply in a same or similar manner to an emission system configured to emit another type of signal, e.g. to an ultrasonic module configured to emit an ultrasonic signal, to a RADAR module configured to emit a RADAR signal, etc.

FIG. 8B shows an exemplary light detection system 100 of the LIDAR system 800B, in which the integrator circuit 106 is configured in accordance with the integrator circuit 300.

FIG. 8C shows an exemplary light detection system 100 of the LIDAR system 800C, in which the integrator circuit 106 is configured in accordance with the integrator circuit 400.

FIG. 8D shows an exemplary light detection system 100 of the LIDAR system 800D, in which the integrator circuit 106 is configured in accordance with the integrator circuit 500.

FIG. 8E and FIG. 8F each show a LIDAR system 800E, 800F in which the integrator circuit 106 is configured in accordance with the integrator circuit 600. Illustratively, the light detection system 100 may include a plurality of integrator circuits 1 to N. Each integrator circuit of the plurality of integrator circuits 1 to N may be configured in accordance with any of the integrator circuits 106, 300, 400, 500 as described herein. For example, each integrator circuit of the plurality of integrator circuits 1 to N may be configured in accordance with the integrator circuit 300 as shown in FIG. 8E. For example, each integrator circuit of the plurality of integrator circuits 1 to N may be configured in accordance with the integrator circuit 500 as shown in FIG. 8F.

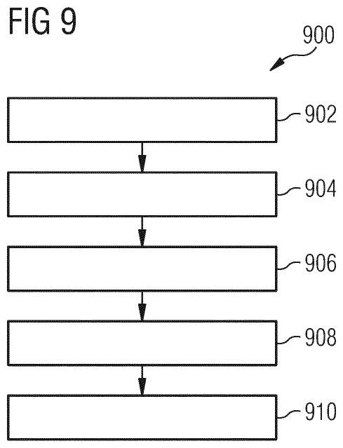

FIG. 9 shows a flow diagram 900 of a method of performing a time measurement according to various aspects.

The method may include detecting a signal (in 902).

The method may include detecting a change of the detected signal from below to above a predefined trigger threshold value (in 904).

The method may include integrating the detected signal after detecting the change of the detected signal from below to above a predefined trigger threshold value and generating an integration value representing a result of the integration of the detected signal over time (in 906).

The method may include determining a time between a provided time measurement start signal (e.g., a time-of-flight start signal) and the detection of the change of the detected signal as a time measurement (e.g., a time-of-flight) associated with the detected signal (in 908).

The method may include determining one or more characteristics of the detected signal using the generated integration value and the predefined trigger threshold value (in 910). According to various aspects, the one or more characteristics may include an energy of the detected signal, a peak value of the detected signal, a time-offset (e.g., a timing-error, e.g., a time difference between a time corresponding to the detected change of the detected signal and a time corresponding to a reference feature (e.g., a reference characteristic, a reference position, a peak value, a half maximum of the detected signal, etc.) of the detected signal) of the detected signal, and/or a confidence of expected properties (e.g., an expected shape of the detected signal, e.g., an expected duration of the detected signal, etc.) of the detected signal.

In the following, various aspects of this disclosure will be illustrated.

Example 1 is a detection system including: a detector circuit configured to detect a signal and to provide the detected signal, an integrator circuit configured to integrate the detected signal responsive to an integration start signal and to generate an integration value representing a result of the integration of the detected signal over time; and a processing circuit configured to: detect a change of the detected signal from below to above a predefined trigger threshold value and, in the case that the change of the detected signal from below to above the predefined trigger threshold value is detected, transmit the integration start signal to the integrator circuit; determine a time between a provided time measurement start signal and the detection of the change of the detected signal as a time measurement associated with the detected signal; and determine one or more characteristics of the detected signal using the generated integration value.

In Example 2, the detection system of Example 1 can optionally include that the one or more characteristics of the detected signal include an energy of the detected signal.

In Example 3, the detection system of Example 1 or 2 can optionally include that the processing circuit is configured to determine the energy of the detected signal using the generated integration value, the predefined trigger threshold value, and expected properties of the detected signal (e.g., an expected shape of the detected signal, e.g., an expected duration of the detected signal, etc.).

In Example 4, the detection system of any one of Examples 1 to 3 can optionally include that the one or more characteristics of the detected signal include a peak value of the detected signal.

In Example 5, the detection system of Example 4 can optionally include that the processing circuit is configured to determine the peak value of the detected signal using the generated integration value and expected properties of the detected signal (e.g., an expected shape of the detected signal, e.g., an expected duration of the detected signal, etc.).

In Example 6, the detection system of Example 5 can optionally include that the processing circuit is configured to determine the peak value of the detected signal using the generated integration value, the expected properties of the detected signal (e.g., an expected shape of the detected signal, e.g., an expected duration of the detected signal, etc.), and the predefined trigger threshold value.

In Example 7, the detection system of any one of Examples 1 to 6 can optionally include that the one or more characteristics of the detected signal include a time difference between a time corresponding to the detected change of the detected signal and a time corresponding to a reference feature (e.g., a reference characteristic, e.g., a reference position, e.g., a peak value, e.g., a half maximum of the detected signal, etc.) of the detected signal.

In Example 8, the detection system of Example 7 can optionally include that the processing circuit is configured to determine the time difference between the time corresponding to the detected change of the detected signal and the time corresponding to the reference feature of the detected signal (e.g., a detected signal pulse) using the generated integration value and expected properties of the detected signal (e.g., an expected shape of the detected signal, e.g., an expected duration of the detected signal, etc.).

In Example 9, the detection system of Example 8 can optionally include that the processing circuit is configured to determine the time difference between the time corresponding to the detected change of the detected signal and the time corresponding to the reference feature of the detected signal using the generated integration value, the expected properties of the detected signal (e.g., an expected shape of the detected signal, e.g., an expected duration of the detected signal, etc.), and the predefined trigger threshold value.

In Example 10, the detection system of any one of Examples 7 to 9 can optionally include that the processing circuit is further configured determine an error-compensated time measurement associated with the detected signal by adapting the determined time measurement using the determined time difference.

In Example 11, the detection system of any one of Examples 1 to 10 can optionally include that the processing circuit is configured to receive a time-of-flight start signal, the time-of-flight start signal indicating a start of an emission of an emitted signal. The detector circuit is configured to detect a delayed and modified version of the emitted signal (e.g., an attenuated version of the emitted signal, e.g., a noisy version of the emitted signal) and to provide the detected delayed and modified version of the emitted signal as the detected signal.

In Example 12, detection system of any one of Examples 1 to 11 can optionally further include a delay circuit configured to delay the detected signal by a predefined time delay (e.g., in the range from 0.1 ns to 200 ns). The integrator circuit is configured to integrate the delayed signal responsive to the integration start signal.

In Example 13, the detection system of any one of Examples 1 to 12 can optionally include that the detected signal is or includes a signal pulse and the integration value represents only a part of an energy of the signal pulse.

In Example 14, the detection system of Example 12 or 13 can optionally include that the signal pulse has a duration in the range from 0.1 ns to 100 ns, for example in the range from 1 ns to 100 ns. As an example at least one light pulse may have a duration of 10 ns.

In Example 15, the detection system of any one of Examples 1 to 14 can optionally include that the detector circuit is configured to provide a voltage or a current representing the detected signal.

In Example 16, the detection system of Example 15 can optionally include that the processing circuit is configured to detect the change of the detected signal by detecting a change of a voltage value or a current value from below to above the predefined trigger threshold value.

In Example 17, the detection system of any one of Examples 1 to 16 can optionally include that the processing circuit includes a trigger comparator configured to output a first trigger signal in the case that a value of the detected signal is greater than the predefined trigger threshold value and to output a second trigger signal in the case that a value of the detected signal is less than the predefined trigger threshold value, and the change of the detected signal corresponds to a change of the output of the trigger comparator (e.g., a change of the output from the second trigger signal to the first trigger signal, e.g., a change of the output from the first trigger signal to the second trigger signal).

In Example 18, the detection system of any one of Examples 1 to 17 can optionally include that the processing circuit is configured to receive a clock signal and to determine a time-of-flight in accordance with the clock signal.

In Example 19, the detection system of any one of Examples 1 to 18 can optionally include that the integrator circuit is configured to stop integrating the detected signal responsive to an integration stop signal.

In Example 20, the detection system of Example 19 can optionally include that the processing circuit is configured to transmit the integration stop signal to the integrator circuit a predefined time period after the integration start signal has been transmitted.

In Example 21, the detection system of any one of Examples 1 to 20 can optionally include that the processing circuit includes at least one of an application-specific integrated circuit (ASIC), a discrete digital circuit, a multi-purpose field programmable array (FPGA), a microcontroller, or a microprocessor.

In Example 22, the detection system of any one of Examples 1 to 21 can optionally include that the detected signal is or includes a detected light signal, and the detection system is a light detection system.

In Example 23, the detection system of Example 22 can optionally include that the detector circuit includes at least one photodiode configured to detect a light signal.

In Example 24, the detection system of Example 23 can optionally include that the at least one photodiode is configured to generate an analog signal representing the detected light signal in response to a light signal impinging onto the at least one photodiode.

In Example 25, the detection system of Example 23 or 24 can optionally include that the at least one photodiode includes at least one of a PIN photodiode, an avalanche photodiode, or a silicon photomultiplier.

In Example 26, the detection system of any one of Examples 23 to 25 can optionally include that the detector circuit further includes an amplifier configured to amplify the analog signal generated by the at least one photodiode.

In Example 27, the detection system of Example 26 can optionally include that the analog signal generated by the at least one photodiode is an analog signal of a first type, and the amplifier is configured to convert the analog signal of the first type into an analog signal of a second type.

In Example 28, the detection system of Example 27 can optionally include that the analog signal of the first type is or includes a current, and the analog signal of the second type is or includes a voltage.

In Example 29, the detection system of any one of Examples 26 to 28 can optionally include that the amplifier is or includes a transimpedance amplifier.

In Example 30, the detection system of any one of Examples 1 to 29 can optionally include that the one or more characteristics of the detected signal include an energy of the detected signal, and the processing circuit is configured to: determine the energy of the detected signal using the generated integration value and a first lookup-table. The first lookup-table includes a respective energy for each integration value of a plurality of integration values.

In Example 31, the detection system of any one of Examples 1 to 30 can optionally include that the one or more characteristics of the detected signal include a peak value of the detected signal, and the processing circuit is configured to: determine the peak value of the detected signal using the generated integration value and a second lookup-table. The second lookup-table includes a respective peak value for each integration value of a plurality of integration values.

In Example 32, the detection system of any one of Examples 1 to 31 can optionally include that the one or more characteristics of the detected signal include a time difference between a time corresponding to the detected change of the detected signal and a time corresponding to a reference feature (e.g., a reference characteristic, e.g., a reference position, e.g., a peak value, e.g., a half maximum of the detected signal, etc.) of the detected signal, and the processing circuit is configured to: determine the time difference using the generated integration value and a third lookup-table. The third lookup-table includes a respective time difference for each integration value of a plurality of integration values.

In Example 33, the detection system of any one of Examples 30 to 32 can optionally further include: a memory device configured to store the first lookup-table, the second lookup-table, and/or the third lookup-table.

In Example 34, the detection system of any one of Examples 1 to 33 can optionally include that the processing circuit is configured to: for each of a plurality of values of a reference feature of a signal having expected properties (e.g., an expected shape of the detected signal, e.g., an expected duration of the detected signal, etc.), determine a respective first time offset between a trigger time associated with the predefined trigger threshold value and a time associated with the respective value of the reference feature, for each of the plurality of values of the reference feature of the signal having the expected properties, determine a respective second time offset such that a value of an integral of the signal from the respective second time offset to infinity is substantially equal to the generated integration value; and determine the time offset corresponding to the value of the reference feature of the plurality of values for which the first time offset is substantially equal to the second time offset as the time difference.

In Example 35, the detection system of any one of Examples 1 to 34 can optionally include that the processing circuit is configured to: for each of a plurality of peak values of a signal having expected properties, determine a respective first time offset between a trigger time associated with the predefined trigger threshold value and a peak time associated with the respective peak value, for each of the plurality of peak values of the signal having the expected properties, determine a respective second time offset such that a value of an integral of the signal from the respective second time offset to infinity is substantially equal to the generated integration value; and determine the time offset corresponding to the peak value of the plurality of peak values for which the first time offset is substantially equal to the second time offset as the time difference.

In Example 36, the detection system of Example 35 can optionally include that the processing circuit is further configured determine the peak value of the detected signal.

In Example 37, the detection system of any one of Examples 1 to 36 can optionally include that the integrator circuit is configured to output the integration value responsive to an integration stop signal.

In Example 38, the detection system of any one of Examples 1 to 37 can optionally include that the integrator circuit includes an integrator configured to integrate the detected signal responsive to the integration start signal.

In Example 39, the detection system of Example 38 can optionally include that the integrator is or includes an operational amplifier integrator (an operational amplifier with a capacitor).

In Example 40, the detection system of Example 38 or 39 can optionally include that the integrator is configured to output an analog output value representing the integration value, and the integrator circuit further includes an analog-to-digital-converter (ADC) configured to detect the analog output value of the integrator and to digitally output a digital representation of the generated integration value.

In Example 41, the detection system of Example 40 can optionally include that the analog-to-digital-converter is configured to digitally output the generated integration value responsive to the integration stop signal.

In Example 42, the detection system of Example 40 or 41 can optionally include that the integrator is configured to set (e.g., clear) a present integration value to a predefined reset value (e.g., “0”) responsive to an integration reset signal, and the processing circuit is configured to transmit the integration reset signal to the integrator.

In Example 43, the detection system of any one of Examples 1 to 42 can optionally include that the integrator circuit further includes an input switch having a first state and a second state. The input switch is configured to switch to the first state responsive to the integration start signal and to switch to the second state responsive to an integration stop signal, and the integrator circuit is configured to integrate the detected signal in the case that the input switch is in the first state and to not integrate the detected signal in the case that the input switch is in the second state.

In Example 44, the detection system of any one of Examples 1 to 43 can optionally include that the processing circuit is configured to: apply an integration reset signal to the integrator circuit, and transmit the integration start signal to the integrator circuit by not applying the integration reset signal, wherein the integrator circuit is configured to integrate the detected signal in the case that the integration reset signal is not applied to the integrator circuit.

In Example 45, the detection system of Example 43 or 44 can optionally include that the integrator circuit includes: an integrator configured to receive the integration start signal from the processing circuit and to output an analog output value representing the integration value, a sample-and-hold circuit configured to sample the analog output value of the integrator and to hold the sampled analog output value substantially constant; and an analog-to-digital-converter (ADC) configured to (e.g., responsive to an ADC readout signal) detect the hold analog output value of the sample-and-hold circuit and to output a digital representation of the generated digital integration value.

In Example 46, the detection system of any one of Examples 1 to 45 can optionally include that the integrator circuit includes: an input switch having a charge state and a discharge state. The input switch is configured to switch to the charge state responsive to the integration start signal and to switch to the discharge state responsive to an integration stop signal, an integrator configured to charge by integrating the detected signal in the case that the input switch is in the charge state and to discharge in the case that the input switch is in the discharge state (e.g., to discharge by integrating a constant reference signal of opposite polarity to the expected polarity of the detected signal). The processing circuit is configured to: transmit the integration stop signal a predefined time period after transmitting the integration start signal; determine a time duration it takes to discharge a capacitor of the integrator; and determine the integration value using the determined time duration it takes to discharge the capacitor.

In Example 47, the detection system of Example 46 can optionally include that the processing circuit is configured to determine the time duration it takes to discharge the capacitor using an integer number of clock cycles between the integration stop signal and a time at which the integrator is discharged below a predefined discharge threshold value (e.g. below a predefined voltage threshold).

In Example 48, the detection system of Example 46 can optionally include that the processing circuit is configured to determine the time duration it takes to discharge the capacitor using the predefined time period and an integer number of clock cycles between the integration start signal and a time at which the integrator is discharged below a predefined discharge threshold value.

In Example 49, the detection system of Example 47 or 48 can optionally further include: a clock signal generator configured to generate a clock signal and to transmit the clock signal to the processing circuit.

In Example 50, the detection system of any one of Examples 1 to 49 can optionally include that the integrator circuit includes: an input switch having a charge state and a discharge state. The input switch is configured to switch to the charge state responsive to the integration start signal and to switch to the discharge state responsive to an integration stop signal, an integrator configured to be continuously charged by integrating the detected signal in the case that the input switch is in the charge state and to be continuously discharged in the case that the input switch is in the discharge state; a discharge comparator configured to output a first discharge signal in the case that a charge of the integrator is greater than a predefined discharge threshold value (e.g., substantially zero) and to output a second discharge signal in the case that a charge of the integrator is less than the predefined discharge threshold value. The processing circuit is configured to: transmit the integration stop signal to the input switch a predefined time period after the integration start signal has been transmitted to the input switch; detect a change of the discharge signal of the discharge comparator from the first discharge signal to the second discharge signal; and determine the integration value using a time duration between the integration start signal and the detected change of the discharge signal of the discharge comparator and/or a time duration between the integration stop signal and the detected change of the discharge signal of the discharge comparator.

In Example 51, the detection system of Examples 17 and 50 can optionally include that the processing circuit is configured to: detect the change of the output of the trigger comparator (e.g., from the second trigger signal to the first trigger signal, or vice versa) as a first signal, detect the change of the discharge signal of the discharge comparator from the first discharge signal to the second discharge signal as a second signal; and generate an encoded signal by combining the first signal and the second signal to a single binary signal.

In Example 52, the detection system of any one of Examples 46 to 51 can optionally include that, in the discharge state of the input switch, the integrator is electrically conductively connected to a reference value (e.g., a reference voltage, e.g., a reference current) via the switch.

In Example 53, the detection system of any one of Examples 1 to 52 can optionally include a plurality of integrator circuits. The plurality of integrator circuits includes the integrator circuit and one or more additional integrator circuits, each of the one or more additional integrator circuits is configured according to the integrator circuit.

In Example 54, the detection system of Example 53 can optionally include that the processing circuit is configured to: transmit a respective integration start signal to each of the plurality of integrator circuits to initiate the integration of the detected signal at a respective time that is different from the time of the other integrator circuits of the plurality of integrator circuits.

In Example 55, the detection system of Example 53 or 54 can optionally include that the processing circuit is configured to: transmit a respective integration start signal to each of the plurality of integrator circuits one after another based on a respective predefined time difference between two consecutively transmitted integration start signals.

In Example 56, the detection system of Example 55 can optionally include that all predefined time differences between transmitting two consecutively transmitted integration start signals are substantially equal.

In Example 57, the detection system of Example 55 or 56 can optionally include that all predefined time differences are selected such that each integrator circuit of the plurality of integrator circuits starts to integrate the detected signal within an expected duration of the detected signal.

In Example 58, the detection system of Example 53 can optionally include that the processing circuit is configured to: transmit a respective integration start signal to each of the plurality of integrator circuits to initiate the integration of the detected signal substantially at the same time, and transmit a respective integration stop signal to each of the plurality of integrator circuits to stop the integration of the detected signal at a respective time that is different from the time of the other integrator circuits of the plurality of integrator circuits.

In Example 59, the detection system of Example 58 can optionally include that the processing circuit is configured to: transmit a respective integration stop signal to each of the plurality of integrator circuits one after another based on a respective predefined time difference between two consecutively transmitted integration stop signals.

In Example 60, the detection system of Example 59 can optionally include that all predefined time differences between transmitting two consecutively transmitted integration stop signals are substantially equal.

In Example 61, the detection system of any one of Examples 53 to 60 can optionally include that each integrator circuit of the plurality of integrator circuits is configured to generate a respective integration value, and the processing circuit is configured to reconstruct a shape of the detected signal using the integration values generated by the plurality of integrator circuits.

In Example 62, the detection system of Example 61 can optionally include that the processing circuit is configured to reconstruct the shape of the detected signal using the generated integration values and the predefined time differences.

In Example 63, the detection system of Example 17 and any one of Examples 53 to 62 can optionally include that each of the plurality of integrator circuits is configured according to Example 46 or 47. The processing circuit is configured to: detect the change of the output of the trigger comparator (e.g., from the second trigger signal to the first trigger signal, or vice versa) as a first signal, for each discharge comparator of the plurality of integrator circuits, detect the change from the first discharge signal to the second discharge signal as a respective second signal; and generate an encoded signal by combining the first signal and the second signals to a single binary signal.

In Example 64, the detection system of any one of Examples 1 to 63 can optionally include that the one or more characteristics of the detected signal include a time difference between a time corresponding to the detected change of the detected signal and a time corresponding to a reference feature of the detected signal. The processing circuit is configured to determine the time difference using the generated integration value and expected properties of the detected signal, the detection system further includes a further integrator circuit configured to integrate the detected signal responsive to a further integration start signal and to generate a further integration value representing a result of the further integration of the detected signal over time; wherein the processing circuit is configured to: transmit the further integration start signal to the further integrator circuit at a further time. The further time is a predefined time period after transmitting the integration start signal to the integrator circuit; determine a further time difference between the time corresponding to the detected change of the detected signal and the time corresponding to the reference feature of the detected signal using the generated further integration value and the expected properties of the detected signal; and determine a confidence of the expected properties of the detected signal by comparing the determined time difference and the determined further time difference (a signal shape verification, reliability; e.g., of expected pulse shape (e.g., the pulse shape of an emitted signal).

In Example 65, the detection system of Example 64 can optionally include that the processing circuit is configured to: determine whether an absolute value of a difference between the determined time difference and the determined further time difference is less than a predefined time difference verification threshold value, and in the case that the absolute value of the difference between the determined time difference and the determined further time difference is less than the predefined time difference verification threshold value, verify the expected properties as properties of the detected signal.

In Example 66, the detection system of Example 64 or 65 can optionally include that the processing circuit is configured to: determine a first peak value of the detected signal using the generated integration value and the expected properties of the detected signal, determine a second peak value of the detected signal using the generated further integration value and the expected properties of the detected signal; and determine the confidence of the expected properties of the detected signal by comparing the determined time difference with the determined further time difference and the determined first peak value with the determined second peak value.

In Example 67, the detection system of Examples 65 and 66 can optionally include that the processing circuit is configured to: determine whether an absolute value of a difference between the determined first peak value and the determined second peak value is less than a predefined peak verification threshold value, in the case that the absolute value of the difference between the determined time difference and the determined further time difference is less than the predefined time difference verification threshold value and that the absolute value of the difference between the determined first peak value and the determined second peak value is less than the predefined peak verification threshold value, verify the expected properties as the properties of the detected signal.

Example 68 is a light detection system including: the detection system according to any one of Examples 1 to 67. The detected signal is a detected light signal.

Example 75 is a LIDAR system including: a light emission system configured to emit a light signal, and the light detection system according to Example 68 configured to detect the emitted light signal as the detected signal.

In Example 70, the LIDAR system of Example 69 can optionally include that the light emission system includes: a light source configured to emit the light signal and a light source driver configured to control the emission of the light signal by the light source.

In Example 71, the LIDAR system of Example 70 can optionally include that the light source driver is configured to control the light emission by the light source in response to a start signal received at the light source driver.

In Example 72, the LIDAR system of Example 70 or 71 can optionally include that the light source includes an optoelectronic light source configured to emit the light signal.

In Example 73, the LIDAR system of Example 72 can optionally include that the light source includes at least one of one or more light emitting diodes or one or more laser diodes.

Example 74 is a method of performing a time measurement, the method including: detecting a signal, detecting a change of the detected signal from below to above a predefined trigger threshold value; integrating the detected signal after detecting the change of the detected signal from below to above the predefined trigger threshold value and generating an integration value representing a result of the integration of the detected signal over time; determining a time between a provided time measurement start signal and the detection of the change of the detected signal as a time measurement associated with the detected signal; and determining one or more characteristics of the detected signal using the generated integration value.

In Example 75, the method of Example 74 can optionally include that the one or more characteristics of the detected signal include an energy of the detected signal.

In Example 76, the method of Example 74 or 75 can optionally include that the one or more characteristics of the detected signal include a peak value of the detected signal.

In Example 77, the method of any one of Examples 74 to 76 can optionally include that the one or more characteristics of the detected signal include a time difference between a time corresponding to the detected change of the detected signal and a time corresponding to a reference feature (e.g., a reference characteristic, e.g., a reference position, e.g., a peak value, e.g., a half maximum of the detected signal, etc.) of the detected signal.

In Example 78, the detection system of any one of Examples 1 to 67 can optionally include that the processing circuit is configured to determine at least one characteristic of the one or more characteristics of the detected signal using the generated integration value and at least one lookup-table, the at least one lookup-table including a respective value of the at least one characteristic for each integration value of a plurality of integration values.

While various implementations have been particularly shown and described with reference to specific aspects, it should be understood by those skilled in the art that various changes in form and detail may be made therein without departing from the spirit and scope as defined by the appended claims. The scope is thus indicated by the appended claims and all changes which come within the meaning and range of equivalency of the claims are therefore intended to be embraced.

### LIST OF REFERENCE SIGNS

100 Detection system
102 Detector circuit
104 Detected signal
106 Integrator circuit
108 Processing circuit
110 Trigger signal
112 Integration start signal
114 Integration value
116 One or more characteristics
118 Energy
120 Time difference
122 Peak value
126 Time measurement start signal
128 Time measurement
130 Compensated time measurement
131 Delay circuit
132 Trigger comparator
134 Trigger comparator output
136 Control logic
142 Integrator
202 First signal
204 Second signal
206 Third signal
208 Fourth signal
212 First graph showing first time offsets
214 Second graph showing second time offsets
300 Integrator circuit
302 Input switch
304 ADC
306 ADC readout signal
400 Integrator circuit
402 Sample-and-hold circuit
404 Sample-and-hold signal
500 Integrator circuit
502 Input switch
504 Discharge comparator
506 Discharge stop signal
600 Integrator circuit
600A First integrator circuit
600B Second integrator circuit
600C N-th integrator circuit
114A First integration value
114B Second integration value
114C N-th integration value
604 Reconstructed signal
610 Diagram
620 Diagram
630 Diagram
640 Diagram
650 Diagram
800A LIDAR system
800B LIDAR system
800C LIDAR system
800D LIDAR system
800E LIDAR system
800F LIDAR system
802 Light emission system
804 Measurement control unit

What is claimed is:

1. A detection system, comprising:
a detector circuit configured to detect a signal and to provide the detected signal;
an integrator circuit configured to integrate the detected signal responsive to an integration start signal and to generate an integration value representing a result of the integration of the detected signal over time; and
a processing circuit configured to:
detect a change of the detected signal from below to above a predefined trigger threshold value and, in the case that the change of the detected signal from below to above the predefined trigger threshold value is detected, transmit the integration start signal to the integrator circuit;
determine a time between a provided time measurement start signal and the detection of the change of the detected signal as a time measurement associated with the detected signal; and
determine one or more characteristics of the detected signal using the generated integration value.

2. The detection system according to claim 1,
wherein the one or more characteristics of the detected signal comprise one or more of: an energy of the detected signal, a peak value of the detected signal, and/or a time difference between a time corresponding to the detected change of the detected signal and a time corresponding to a reference feature of the detected signal.

3. The detection system according to claim 2,
wherein the one or more characteristics of the detected signal comprise the time difference; and
wherein the processing circuit is further configured determine an error-compensated time measurement associated with the detected signal by adapting the determined time measurement using the determined time difference.

4. The detection system according to claim 1,
wherein the processing circuit comprises a trigger comparator configured to output a first trigger signal in the case that a value of the detected signal is greater than the predefined trigger threshold value and to output a second trigger signal in the case that a value of the detected signal is less than the predefined trigger threshold value; and
wherein the change of the detected signal corresponds to a change of the output of the trigger comparator.

5. The detection system according to claim 1,
wherein the processing circuit is configured to determine at least one characteristic of the one or more characteristics of the detected signal using the generated integration value and at least one lookup-table, the at least one lookup-table comprising a respective value of the at least one characteristic for each integration value of a plurality of integration values.

6. The detection system according to claim 1, further comprising:
a delay circuit configured to delay the detected signal by a predefined time delay;
wherein the integrator circuit is configured to integrate the delayed signal responsive to the integration start signal.

7. The detection system according to claim 1,
wherein the integrator circuit comprises:
an input switch having a first state and a second state, wherein the input switch is configured to switch to the first state responsive to the integration start signal and to switch to the second state responsive to an integration stop signal; and
an integrator configured to integrate the detected signal responsive to the integration start signal in the case that the input switch is in the first state.

8. The detection system according to claim 1,
wherein the integrator circuit comprises:
an integrator configured to receive the integration start signal from the processing circuit and to output an analog output value representing the integration value;
a sample-and-hold circuit configured to sample the analog output value of the integrator and to hold the sampled analog output value substantially constant; and
an analog-to-digital-converter configured to, responsive to an ADC readout signal, detect the hold analog output value of the sample-and-hold circuit and to output a digital representation of the digital generated integration value.

9. The detection system according to claim 1,
wherein the integrator circuit comprises:
an input switch having a charge state and a discharge state, wherein the input switch is configured to switch to the charge state responsive to the integration start signal and to switch to the discharge state responsive to an integration stop signal;
an integrator configured to charge by integrating the detected signal in the case that the input switch is in the charge state and to discharge by integrating a constant reference signal of opposite polarity to the expected polarity of the detected signal, in the case that the input switch is in the discharge state;
wherein the processing circuit is configured to:
transmit the integration stop signal a predefined time period after transmitting the integration start signal;
determine a time duration it takes to discharge the integrator; and
generate the integration value using the determined time duration it takes to discharge the integrator.

10. The detection system according to claim 1, comprising:
a plurality of integrator circuits, wherein the plurality of integrator circuits comprises the integrator circuit and one or more additional integrator circuits, wherein each of the one or more additional integrator circuits is configured according to the integrator circuit.

11. The detection system according to claim 10, wherein the processing circuit is configured to:
transmit a respective integration start signal to each of the plurality of integrator circuits to initiate the integration of the detected signal at a respective time that is different from the time of the other integrator circuits of the plurality of integrator circuits; and/or
to transmit a respective integration stop signal to each of the plurality of integrator circuits to stop the integration of the detected signal at a respective time that is different from the time of the other integrator circuits of the plurality of integrator circuits.

12. The detection system according to claim 11,
wherein each integrator circuit of the plurality of integrator circuits is configured to generate a respective integration value; and
wherein the processing circuit is configured to reconstruct a shape of the detected signal and/or to determine a confidence of expected properties of the detected signal using the integration values generated by the plurality of integrator circuits.

13. A LIDAR system, comprising:
a light emission system configured to emit a light signal; and
a detection system comprising:
a detector circuit configured to detect a signal and to provide the detected signal:
an integrator circuit configured to integrate the detected signal responsive to an integration start signal and to generate an integration value representing a result of the integration of the detected signal over time; and
a processing circuit configured to:
detect a change of the detected signal from below to above a predefined trigger threshold value and, in the case that the change of the detected signal from below to above the predefined trigger threshold value is detected, transmit the integration start signal to the integrator circuit:
determine a time between a provided time measurement start signal and the detection of the change of the detected signal as a time measurement associated with the detected signal; and
determine one or more characteristics of the detected signal using the generated integration value,
wherein the detection system is further configured to detect a delayed and modified version of the emitted light signal as the detected signal.

14. A method of performing a time measurement, the method comprising:
detecting a signal;
detecting a change of the detected signal from below to above a predefined trigger threshold value;
integrating the detected signal after detecting the change of the detected signal from below to above the predefined trigger threshold value and generating an integration value representing a result of the integration of the detected signal over time;
determining a time between a provided time measurement start signal and the detection of the change of the detected signal as a time measurement associated with the detected signal; and
determining one or more characteristics of the detected signal using the generated integration value.

15. The method according to claim 14,
wherein the one or more characteristics of the detected signal comprise one or more of: an energy of the detected signal, a peak value of the detected signal, a time difference between a time corresponding to the detected change of the detected signal and a time corresponding to a reference feature of the detected signal, and/or
a confidence of expected properties of the detected signal.
